(19) United States
(12) Patent Application Publication
(10) Pub. No.: US 2024/0413871 A1
(43) Pub. Date: Dec. 12, 2024

(54) METHODS AND SYSTEMS FOR TIME SPREAD ASSEMBLED CSI FOR WIDEBAND CHANNELS

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/700,548

(22) PCT Filed: Oct. 26, 2022
(86) PCT No.: PCT/IB2022/060298

§ 371 Date: Apr. 11, 2024

Related U.S. Application Data
(60) Provisional application No. 63/284,314, filed on Nov. 30, 2021.
(60) Provisional application No. 63/273,556, filed on Oct. 29, 2021.

(51) Int. Cl. H04B 7/06; H04W 84/12

(52) U.S. Cl. CPC H04B 7/0626; H04W 84/12

(57) ABSTRACT

Methods and systems for Wi-Fi sensing carried out by a sensing agent coupled to a transmitting antenna, a receiving antenna, and at least one processor are provided. A sensing agent determines a time window. The sensing agent receives channel state information (CSI) in a frequency domain; generated, by the at least one processor, based on a plurality of sensing transmissions received, via the receiving antenna, from a sensing transmitter in the time window, each of the plurality of sensing transmissions having corresponding CSI. The sensing agent identifies selected CSI from among the corresponding CSI. The sensing agent combines the selected CSI to generate assembled channel state information (A-CSI). The sensing agent sends information representative of the A-CSI to a sensing algorithm manager.

### CROSS-REFERENCE TO RELATED APPLICATIONS

The present application claims benefit of U.S. Provisional Appl. No. 63/273,556, filed Oct. 29, 2021, and U.S. Provisional Appl. No. 63/284,314, filed Nov. 30, 2021, the entire contents of which are incorporated by reference herein.

### TECHNICAL FIELD

The present disclosure generally relates to systems and methods for Wi-Fi sensing. In particular, the present disclosure relates to systems and methods for time spread assembled channel state information (A-CSI) for wideband channels.

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems. A Wi-Fi sensing system is one recent addition to motion detection systems. The Wi-Fi sensing system may be a network of Wi-Fi-enabled devices that may be a part of an IEEE 802.11 network. In an example, the Wi-Fi sensing system may be configured to detect features of interest in a sensing space. The sensing space may refer to any physical space in which the Wi-Fi sensing system may operate, such as a place of residence, a place of work, a shopping mall, a sports hall or sports stadium, a garden, or any other physical space. The features of interest may include motion of objects and motion tracking, presence detection, intrusion detection, gesture recognition, fall detection, breathing rate detection, and other applications.

In IEEE 802.11ac and newer versions of the IEEE standard, channels may be formed by concatenating multiple contiguous component bands. The concatenated multiple contiguous component bands as a whole entity may be referred to as a wideband. For Wi-Fi sensing, using a wideband is advantageous as the wideband improves bandwidth efficiency and time resolution. Therefore, it may be useful to have a transmitter transmit a sensing transmission across the entirety of a wideband channel.

In the Wi-Fi sensing system, information that is representative of a propagation channel (i.e., channel representation information) may need to be transmitted from one device to another device (for example, from a receiver to a transmitter) over the air. The representation of the propagation channel between devices is captured in channel state information (CSI). In the Wi-Fi sensing system having multiple transmitters and receivers, CSI of the system bandwidth may not be used as it is for motion sensing as the signal subject to measurement may not have been transmitted by the same transmitter. For motion sensing, the particular part of the CSI pertaining to the bandwidth associated with a particular transmitter may be used. In an example, the entire bandwidth may not be available to allocate to one transmitter for a sensing transmission in a single transmission opportunity (TXOP) as it is highly likely that other transmitters may also be scheduled to transmit data in that TXOP. Sensing transmissions from the same transmitter that are non-contiguous in frequency may be combined, however the frequency gaps where there are no measurements may need to be estimated. However, this may degrade the signal-to-interference and noise ratio (SINR) which may make the sensing measurement less reliable for detecting motion.

### BRIEF SUMMARY OF THE DISCLOSURE

The present disclosure generally relates to systems and methods for Wi-Fi sensing. In particular, the present disclosure relates to systems and methods for time spread assembled channel state information (A-CSI) for wideband channels.

System and methods are provided for Wi-Fi sensing. In an example embodiment, a method for Wi-Fi sensing is described. A method for Wi-Fi sensing is carried out by a sensing receiver. The sensing receiver includes a transmitting antenna, a receiving antenna, and at least one processor configured to execute instructions. The method comprises determining a time window, receiving a plurality of sensing transmissions from a sensing transmitter in the time window, generating channel state information (CSI) in a frequency domain based on the plurality of sensing transmissions, where each of the plurality of sensing measurements having corresponding CSI, identifying selected CSI from among the corresponding CSI, combining the selected CSI to generate assembled channel state information (A-CSI), and sending information representative of the A-CSI to a sensing algorithm manager.

In some embodiments, the information representative of the A-CSI includes the A-CSI.

In some embodiments, the method further includes generating time domain channel representation information (TD-CRI) of the A-CSI, where the information representative of the A-CSI includes the TD-CRI.

In some embodiments, identifying the selected CSI includes identifying, as the selected CSI, the corresponding CSI associated with the sensing transmissions associated with contiguous component bands from the sensing transmitter.

In some embodiments, identifying the selected CSI includes identifying, as first selected CSI, the corresponding CSI associated with the sensing transmissions associated with first contiguous component bands from the sensing transmitter and identifying, as second selected CSI, the corresponding CSI associated with the sensing transmissions associated with second contiguous component bands from the sensing transmitter.

In some embodiments, the plurality of sensing transmissions are a first plurality of sensing transmissions from a first sensing transmitter.

In some embodiments, the method further includes receiving a second plurality of sensing transmissions from a second sensing transmitter in the time window, where generating the CSI is performed based on the first plurality of sensing transmissions and the second plurality of sensing transmissions. Each of the first plurality of sensing measurements having corresponding CSI and each of the second plurality of sensing measurements having corresponding CSI.

In some embodiments, identifying the selected CSI includes identifying, as a first selected CSI, the corresponding CSI associated with first sensing transmissions associated with contiguous component bands from the first sensing transmitter and identifying, as a second selected CSI, the corresponding CSI associated with second sensing transmissions associated with contiguous component bands from the second sensing transmitter.

In some embodiments, combining the selected CSI to generate A-CSI includes combining the first selected CSI to generate first A-CSI and combining the second selected CSI to generate second A-CSI.

In some embodiments, sending information representative of the A-CSI to the sensing algorithm manager includes sending first information representative of the first A-CSI and sending second information representative of the second A-CSI to the sensing algorithm manager.

In some embodiments, the method further includes receiving a subsequent sensing transmission from the sensing transmitter after the time window, shifting the time window to include the subsequent sensing transmission and a portion of the plurality of sensing transmissions, and generating a subsequent CSI based on the subsequent sensing transmission, and combining the subsequent CSI with a portion of the selected CSI to generate subsequent A-CSI.

In some embodiments, the method further includes receiving a subsequent sensing transmission after the time window and determining a subsequent time window configured to encompass a plurality of subsequent transmissions received after the time window.

In some embodiments, the time window is a predetermined length of time.

In some embodiments, the time window is configured to encompass a predetermined number of transmission opportunity periods.

In some embodiments, during each of the predetermined number of transmission opportunity periods, one sensing transmission from one sensing transmitter is received.

In some embodiments, identifying the selected CSI includes determining that corresponding CSI associated with a first sensing transmission of the plurality of sensing transmissions and corresponding CSI associated with a second sensing transmission of the plurality of sensing transmissions are associated with same component bands from the sensing transmitter, including the corresponding CSI associated with the second sensing transmission in the selected CSI, and excluding the CSI associated with the first sensing transmission in the selected CSI. The second sensing transmission is received later in time than the first sensing transmission.

In some embodiments, identifying the selected CSI includes determining that corresponding CSI associated with a first sensing transmission of the plurality of sensing transmissions and corresponding CSI associated with a second sensing transmission of the plurality of sensing transmissions are associated with same component bands from the sensing transmitter, including the corresponding CSI associated with the first sensing transmission in the selected CSI and discarding the CSI associated with the second sensing transmission in the selected CSI. The second sensing transmission is received later in time than the first sensing transmission.

In some embodiments, identifying the selected CSI includes determining that corresponding CSI associated with a first sensing transmission of the plurality of sensing transmissions and corresponding CSI associated with a second sensing transmission of the plurality of sensing transmissions are associated with same component bands from the sensing transmitter, wherein the second sensing transmission is received later in time than the first sensing transmission, combining the corresponding CSI associated with the first sensing transmission and the CSI associated with the second sensing transmission, and including the combined CSI in the selected CSI.

In an example embodiment, a system for Wi-Fi sensing is described. The system comprises a sensing receiver. The sensing receiver includes a transmitting antenna, a receiving antenna, and at least one processor. The at least one processor is configured to execute instructions for determining a time window, receiving channel state information (CSI) in a frequency domain generated based on a plurality of sensing transmissions received, via the receiving antenna, from a sensing transmitter in the time window, each of the plurality of sensing transmissions having corresponding CSI, identifying selected CSI from among the corresponding CSI, combining the selected CSI to generate assembled channel state information (A-CSI), and sending information representative of the A-CSI to a sensing algorithm manager.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system.

FIG. 2A and FIG. 2B are diagrams showing example wireless signals communicated between wireless communication devices.

FIG. 3A and FIG. 3B are plots showing examples of channel responses computed from the wireless signals communicated between wireless communication devices in FIG. 2A and FIG. 2B.

FIG. 4A and FIG. 4B are diagrams showing example channel responses associated with motion of an object in distinct regions of a space.

FIG. 4C and FIG. 4D are plots showing the example channel responses of FIG. 4A and FIG. 4B overlaid on an example channel response associated with no motion occurring in the space.

FIG. 5 depicts an implementation of some of an architecture of an implementation of a system for Wi-Fi sensing, according to some embodiments.

FIG. 6A illustrates a structure of an Aggregated-Medium Access Control (MAC)-layer Protocol Data Unit (A-MPDU) frame and FIG. 6B illustrates a structure of an A-MPDU subframe, according to some embodiments.

FIG. 7A to FIG. 7H depict a hierarchy of fields within a trigger frame, according to some embodiments.

FIG. 8A depicts a Wi-Fi sensing system with three sensing transmitters and one sensing receiver, according to some embodiments.

FIG. 8B and FIG. 8C depict channel perturbation impacting transmission paths between sensing transmitters and a sensing receiver, according to some embodiments.

FIG. 9 depicts an example of allocation of an 80 MHz channel bandwidth into component bands, according to some embodiments.

FIG. 10A illustrates an example of assembly of channel state information (CSI) for a sensing transmitter across multiple orthogonal frequency-division multiplexing (OFDM) equal bursts in a time window, according to some embodiments.

FIG. 10B illustrates an example of assembly of CSI for a sensing transmitter across multiple OFDM unequal bursts in a time window, according to some embodiments.

FIG. 10C illustrates an example of assembly of CSI for one sensing transmitter across multiple unequal OFDM bursts in a time window with overwrite, according to some embodiments.

FIG. 10D illustrates an example of assembly of CSI for one sensing transmitter across multiple unequal OFDM bursts in a time window with discard, according to some embodiments.

FIG. 10E illustrates an implementation of assembly of CSI for one sensing transmitter across multiple unequal OFDM bursts in a time window with average, according to some embodiments.

FIG. 10F illustrates an assembly of CSI for one sensing transmitter across multiple equal OFDM bursts in a time window of period T_{A} with minimal shift, according to some embodiments.

FIG. 10G illustrates an assembly of CSI for one sensing transmitter across multiple unequal OFDM bursts in a time window with minimal shift, according to some embodiments.

FIG. 10H and FIG. 10I illustrates an assembly of CSI for one sensing transmitter across multiple equal OFDM bursts in a time window with fixed shift, according to some embodiments.

FIG. 10J illustrates an assembly of CSI across equal OFDM bursts from multiple transmitters in a time window, according to some embodiments.

FIG. 10K an exemplary implementation of multiple transmitters transmitting in different component bands in the same TXOP, according to some embodiments.

FIG. 10L an exemplary implementation of multiple transmitters transmitting during a time window, according to some embodiments.

FIG. 11A and FIG. 11B illustrate a flowchart for a Wi-Fi sensing carried out by a sensing receiver, according to some embodiments.

FIG. 12A and FIG. 12B illustrates a flowchart for a Wi-Fi sensing carried out by a sensing receiver coupled to multiple sensing transmitters, according to some embodiments.

### DETAILED DESCRIPTION

In some aspects of what is described herein, a wireless sensing system may be used for a variety of wireless sensing applications by processing wireless signals (e.g., radio frequency signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access-point (AP) assumes the receiver role, and each Wi-Fi device (stations, nodes, or peers) connected to the AP assume the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference while others experience destructive interference.

The channel information for each of the communication links may be analyzed (e.g., by a hub device or other device in a wireless communication network, a sensing transmitter, sensing receiver or sensing algorithm manager communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered less frequently. In some implementations, when motion is present, for example, the wireless sensing system can increase the triggering rate to produce a time-series of measurements with finer time resolution. Controlling the variable measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or Extended Service Set (ESS) topology, multiple coordinating wireless access-points (APs) each provide a Basic Service Set (BSS) which may occupy different frequency bands and allow devices to transparently move between from one participating AP to another (e.g., mesh). For instance, within a home mesh network, Wi-Fi devices can connect to any of the APs, but typically select one with a good signal strength. The coverage footprint of the mesh APs typically overlaps, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformer) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on the environment conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell-phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the document are provided below.

A term “measurement campaign” may refer to a bi-directional series of one or more sensing transmissions between a sensing receiver and a sensing transmitter that allows a series of one or more sensing measurements to be computed.

A term “transmission opportunity (TXOP)” may refer to a negotiated interval of time during which a particular quality of service (QoS) station (e.g., a sensing initiator or sensing transmitter) may have the right to initiate a frame exchange onto a wireless medium. A QoS access category (AC) of the transmission opportunity may be requested as part of a negotiation.

A term “Quality of Service (QoS) access category (AC)” may refer to an identifier for a frame which classifies a priority of transmission that the frame requires. In an example, four QoS access categories are defined namely AC_VI: Video, AC_VO: Voice, AC_BE: Best-Effort, and AC_BK: Background. Further, each QoS access category may have differing transmission opportunity parameters defined for it.

A term “transmission parameters” may refer to a set of IEEE 802.11 PHY transmitter configuration parameters which are defined as a part of transmission vector (TXVECTOR) corresponding to a specific PHY and which are configurable for each PHY-layer protocol data unit (PPDU) transmission.

A term “Null Data PPDU (NDP)” may refer to a PPDU that does not include data field. In an example, Null Data PPDU may be used for sensing transmission where it is the MAC header that includes the information required.

A term “Channel State Information (CSI)” may refer to properties of a communications channel that are known or measured by a technique of channel estimation. CSI may represent how wireless signals propagate from a transmitter (for example, a sensing transmitter) to a receiver (for example, a sensing receiver) at certain carrier frequencies along multiple paths. CSI for each frequency may include a complex value representing amplitude attenuation and phase shift of multipath Wi-Fi channel. The CSI amplitude and phase may be impacted by displacements and movements of transmitters, receivers, and surrounding objects and humans.

A term “time-domain channel representation information (TD-CRI)” may refer to a series of complex pairs representing the amplitude and delay of time domain pulses which are created by performing an inverse discrete Fourier transform (IDFT) on CSI values, for example CSI calculated by a baseband receiver.

A term “inverse discrete Fourier transform (IDFT)” may refer to an algorithm which transforms a signal in frequency domain to a signal in time domain. In an example, the IDFT may be used to transform a CSI into a TD-CRI. In an embodiment, an inverse fast Fourier transform (IFFT) may be used to implement the IDFT.

A term “time domain pulse” may refer to a complex number that represents amplitude and phase of discretized energy in the time domain. When CSI values are obtained for each tone from the baseband receiver, time domain pulses are obtained by performing an IFFT on the CSI values.

A term “resource unit (RU)” may refer to an allocation of orthogonal frequency division multiplexing (OFDM) channels which may be used to carry a modulated signal. An RU may include a variable number of carriers depending on the mode of the modem.

A term “sensing transmitter” may refer to a device that sends a transmission (for example, PPDUs) used for sensing measurements (for example, channel state information) in a sensing session. In an example, a station is an example of a sensing transmitter. In some examples, an access point may also be a sensing transmitter for Wi-Fi sensing purposes in the example where a station acts as a sensing receiver.

A term “sensing receiver” may refer to a device that receives a transmission (for example, PPDUs) sent by a sensing transmitter and performs one or more sensing measurements (for example, channel state information) in a sensing session. An access point is an example of a sensing receiver. In some examples, a station may also be a sensing receiver, for example in a mesh network scenario.

A term “sensing initiator” may refer to a device that initiates a Wi-Fi sensing session. The role of sensing initiator may be taken on by the sensing receiver, the sensing transmitter, or a separate device which includes a sensing algorithm (for example, a sensing algorithm manager).

A term “channel representation information (CRI)” may refer to a collection of sensing measurements which together represent the state of the channel between two devices. Examples of CRI are CSI and TD-CRI.

A term “sensing trigger message” may refer to a message sent from the sensing receiver to the sensing transmitter to trigger one or more sensing transmissions that may be used for performing sensing measurements. A sensing trigger message may also be referred to as a sensing initiation message.

A term “uplink orthogonal frequency division multiple access (UL-OFDMA) sensing trigger message” may refer to a message from the sensing receiver to one or more sensing transmitters to generate a sensing transmission in a single transmission opportunity (TXOP) using UL-OFDMA. The UL-OFMDA sensing trigger message includes data which instructs the one or more sensing transmitters how to form sensing transmissions in response to the UL-OFMDA sensing trigger message.

A term “sensing response message” may refer to a message which is included within a sensing transmission from the sensing transmitter to the sensing receiver. In an example, the sensing transmission that includes the sensing response message may be used to perform a sensing measurement.

A term “sensing transmission” may refer to a transmission made from the sensing transmitter to the sensing receiver which may be used to make a sensing measurement. In an example, a sensing transmission may also be referred to as wireless sensing signal or wireless signal.

A term “sensing measurement” may refer to a measurement of a state of a channel i.e., CSI measurement between the sensing transmitter and the sensing receiver derived from a sensing transmission.

A term “sensing goal” may refer to a goal of a sensing activity at a time. A sensing goal is not static and may change at any time. In an example, the sensing goal may require sensing measurements of a specific type, a specific format, or a specific precision, resolution, or accuracy to be available to a sensing algorithm.

A term “sensing algorithm” may refer to a computational algorithm that achieves a sensing goal. The sensing algorithm may be executed on any device in a Wi-Fi sensing system.

A term “tone” may refer to an individual subcarrier in an OFDM signal. A tone may be represented in time domain or frequency domain. In the time domain, a tone may also be referred to as a symbol. In the frequency domain, a tone may also be referred to as a subcarrier.

A term “delivered transmission configuration” may refer to transmission parameters applied by the sensing transmitter to a sensing transmission.

A term “requested transmission configuration” may refer to requested transmission parameters of a sensing transmitter to be used when sending a sensing transmission.

A term “component bandwidth” may refer to a subject of channel bandwidth. Component bandwidth may be a subchannel, for example, a 20 MHz or 40 MHz subchannel in an 80 MHz channel bandwidth. In other examples, a component bandwidth may include a number of contiguous RUs that are a subset of the smallest channel size (i.e., 20 MHz), or a non-integer multiple of the smallest channel size.

A term “OFDM burst” may refer to a transmission that takes place in a frame of a TXOP. An OFDM burst may include one or more training fields that make up a preamble, as well as optionally signal and data fields. Longer OFDM bursts, for example as may be used in 802.1 lax, may include one or more training fields in both a preamble and a mid-amble. CSI measurements are performed on the training fields transmitted as part of the OFDM burst.

A term “T_{A} window” may refer to the time duration over which CSI for the same sensing transmitter can be assembled without losing too much fidelity in the detection of movement based on the CSI. In examples, the T_{A} window is less than or equal to the coherence time of the wireless channel.

A term “Wi-Fi sensing session” may refer to a period during which objects in a physical space may be probed, detected and/or characterized. In an example, during a Wi-Fi sensing session, several devices participate in, and thereby contribute to the generation of sensing measurements. A Wi-Fi sensing session may also be referred to as a wireless local area network (WLAN) sensing session or simply a sensing session.

A term “steering matrix configuration” may refer to a matrix of complex values representing real and complex phase required to pre-condition antenna of a radio frequency (RF) transmission signal chain for each transmit signal. Application of the steering matrix configuration (for example, by a spatial mapper) enables beamforming and beam-steering.

A term “spatial mapper” may refer to a signal processing element that adjusts the amplitude and phase of a signal input to an RF transmission chain in a station or a sensing transmitter. The spatial mapper may include elements to process the signal to each RF chain implemented. The operation carried out is called spatial mapping. The output of the spatial mapper is one or more spatial streams.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of methods and systems for time spread assembled channel state information (A-CSI) for wideband channels.

### A. Wireless Communications System, Wireless Transmissions and Sensing Measurements

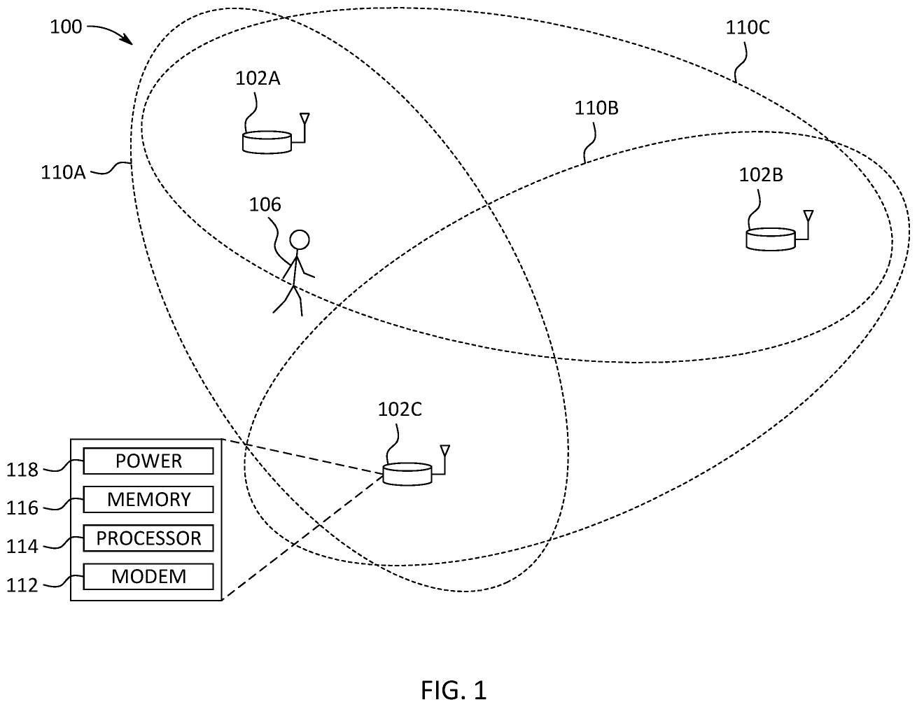

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi access points or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SoN, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate radio frequency (RF) signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and radio frequency circuitry. The radio frequency circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to radio frequency (RF) signals, and wirelessly transmits the radio frequency signals (e.g., through an antenna). In some instances, the radio subsystem in modem 112 wirelessly receives radio frequency signals (e.g., through an antenna), down-converts the radio frequency signals to baseband signals and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

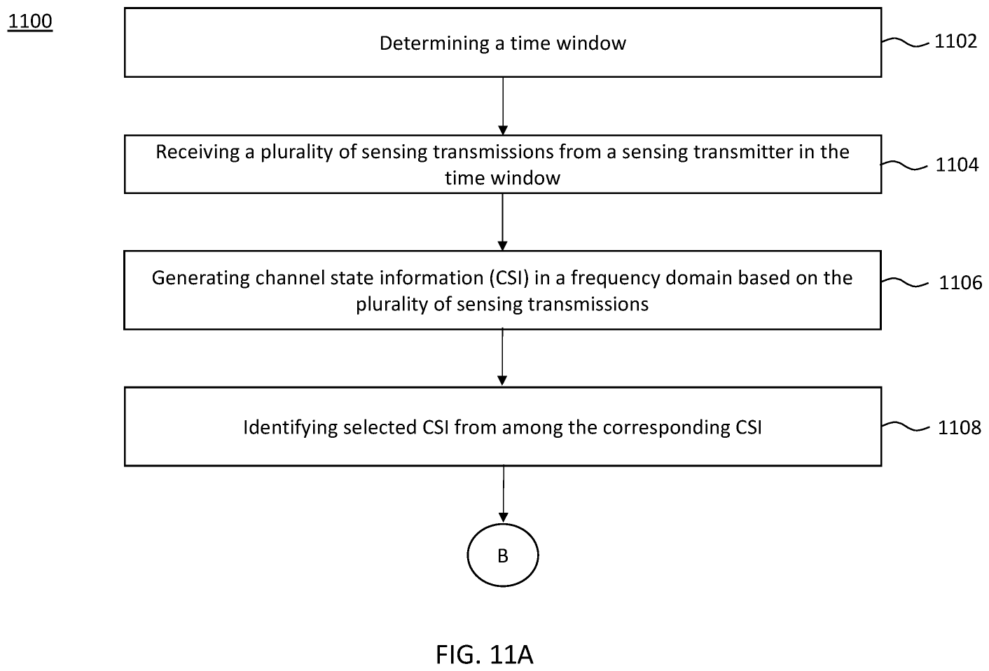

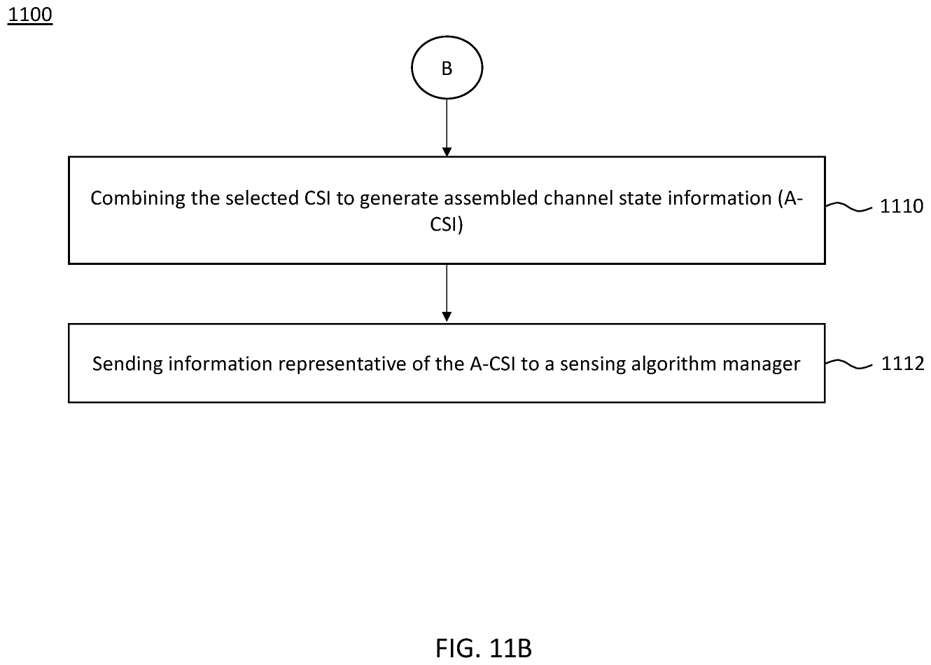

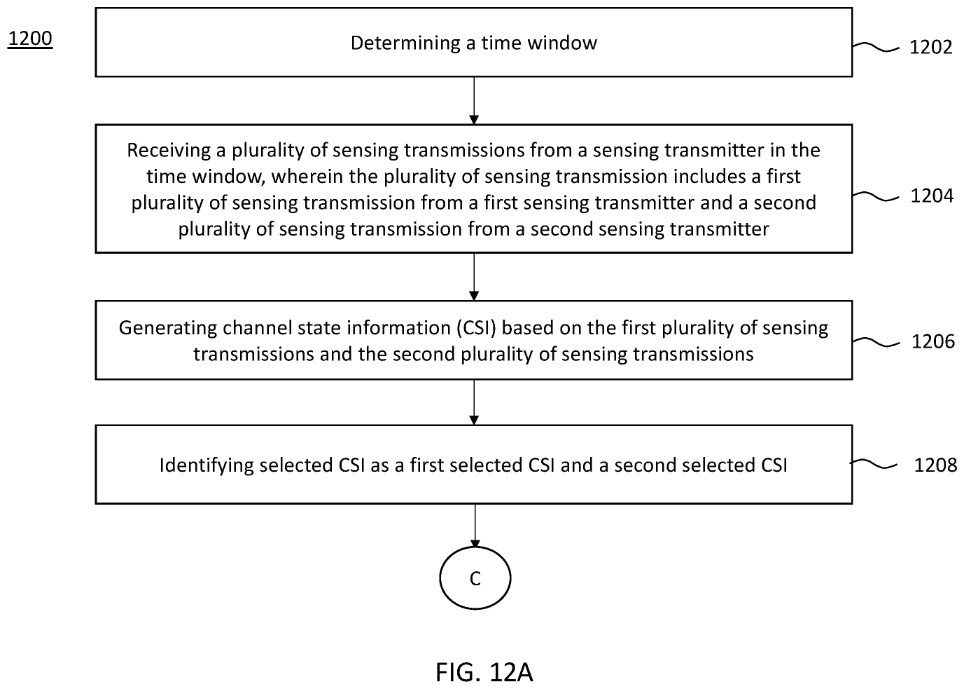

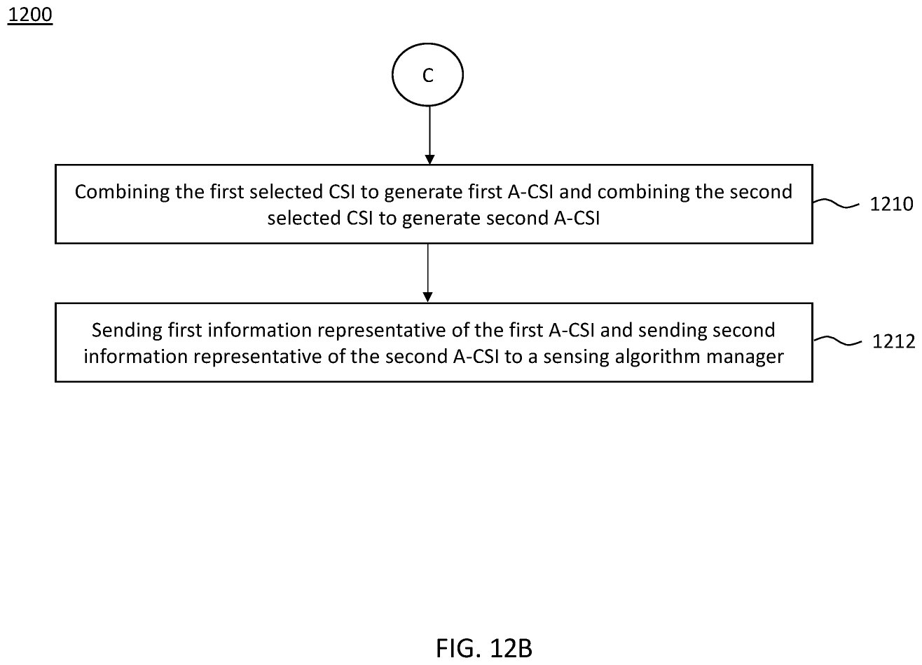

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for calculating time spread assembled channel state information (A-CSI) for wideband channels, such as through one or more of the operations of the example processes described in FIG. 11A, FIG. 11B, FIG. 12A, and FIG. 12B.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an AC adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 11A, FIG. 11B, FIG. 12A, and FIG. 12B or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 18A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

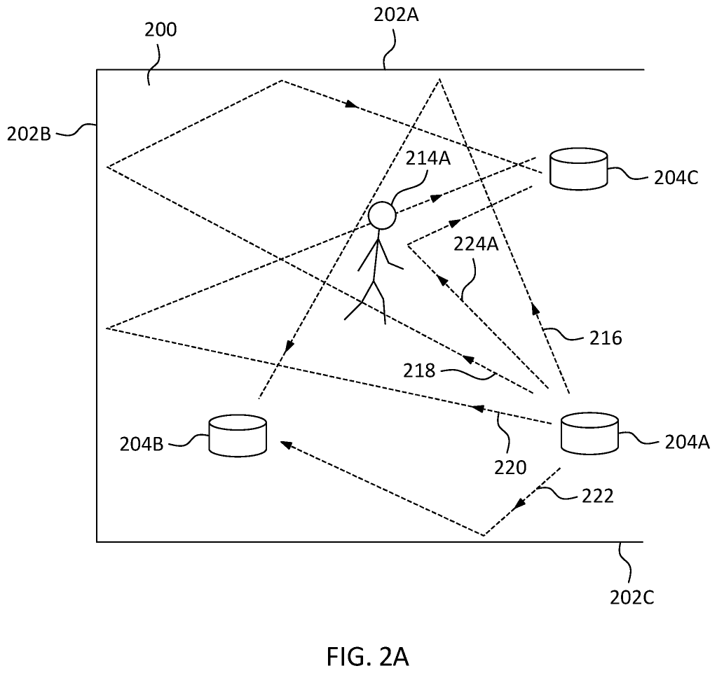

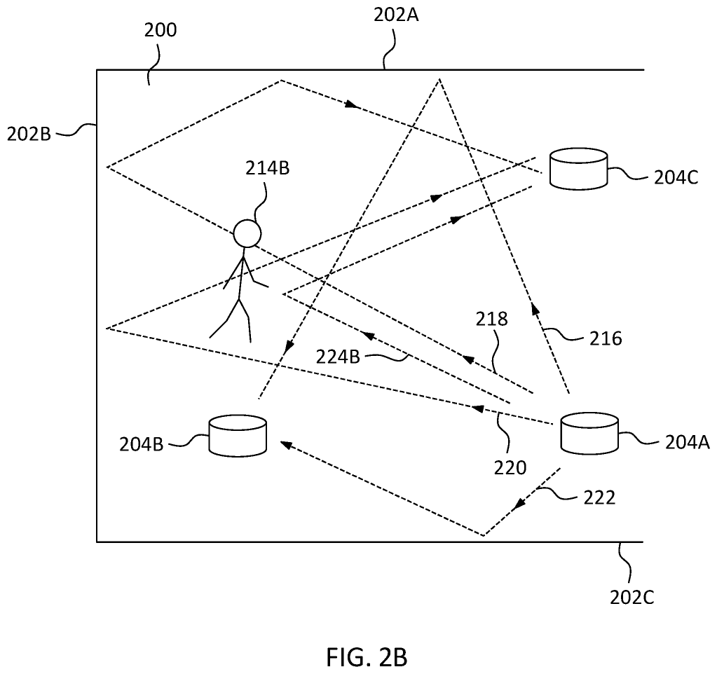

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIGS. 2A and 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f(t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the transmitted signal f(t) being transmitted from the first wireless communication device 204A, an output signal rₖ(t) from a path k may be described according to Equation (2):

$${r}_{k} ( t ) = {\sum }_{n = - ∞}^{∞} {α}_{n . k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along path k, and ϕ_{n,k} represents the phase of the signal for nth frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

The received signal R at a wireless communication device can then be analyzed. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency on, a complex value Hₙ may be represented as follows in Equation (5):

$${H}_{n} = {\sum }_{k} {c}_{n} {α}_{n , k} {e}^{j {ϕ}_{n , k}} \qquad ( 5 )$$

The complex value Hₙ for a given frequency component ωₙ indicates a relative magnitude and phase offset of the received signal at that frequency component on. When an object moves in the space, the complex value H₁ changes due to the channel response αn,k of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{c h} = {\sum }_{k} {\sum }_{n = - ∞}^{∞} {α}_{n , k} \qquad ( 6 )$$

In some instances, the channel response h_{ch} for a space can be determined, for example, based on the mathematical theory of estimation. For instance, a reference signal Ref can be modified with candidate channel responses (h_{ch}), and then a maximum likelihood approach can be used to select the candidate channel which gives best match to the received signal (Rcvd). In some cases, an estimated received signal (\hat{R}_{cvd}) is obtained from the convolution of the reference signal (Ref) with the candidate channel responses (h_{ch}), and then the channel coefficients of the channel response (h_{ch}) are varied to minimize the squared error of the estimated received signal (\hat{R}_{cvd}). This can be mathematically illustrated as follows in Equation (7):

$${R}_{c v d} = {R}_{e f} ⊗ {h}_{c h} = {\sum }_{k = - m}^{m} {R}_{e f} ( n - k ) {h}_{c h} ( k ) \qquad ( 7 )$$

with the optimization criterion

$${min}_{{h}_{ch}} \sum {( {\hat{R}}_{c v d} - {R}_{cvd} )}^{2}$$

The minimizing, or optimizing, process can utilize an adaptive filtering technique, such as Least Mean Squares (LMS), Recursive Least Squares (RLS), Batch Least Squares (BLS), etc. The channel response can be a Finite Impulse Response (FIR) filter, Infinite Impulse Response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

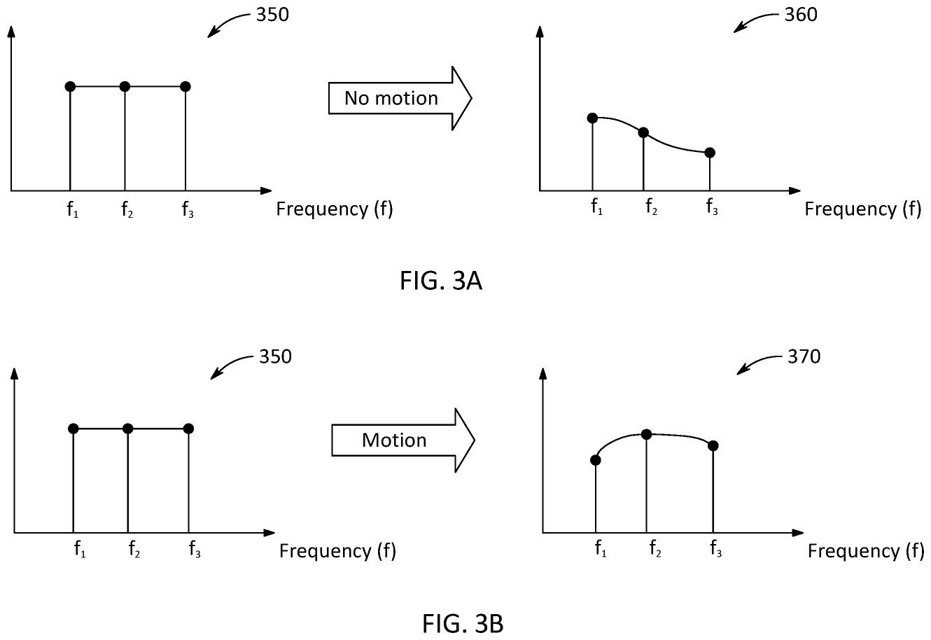

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component f1, f2, and f3 is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

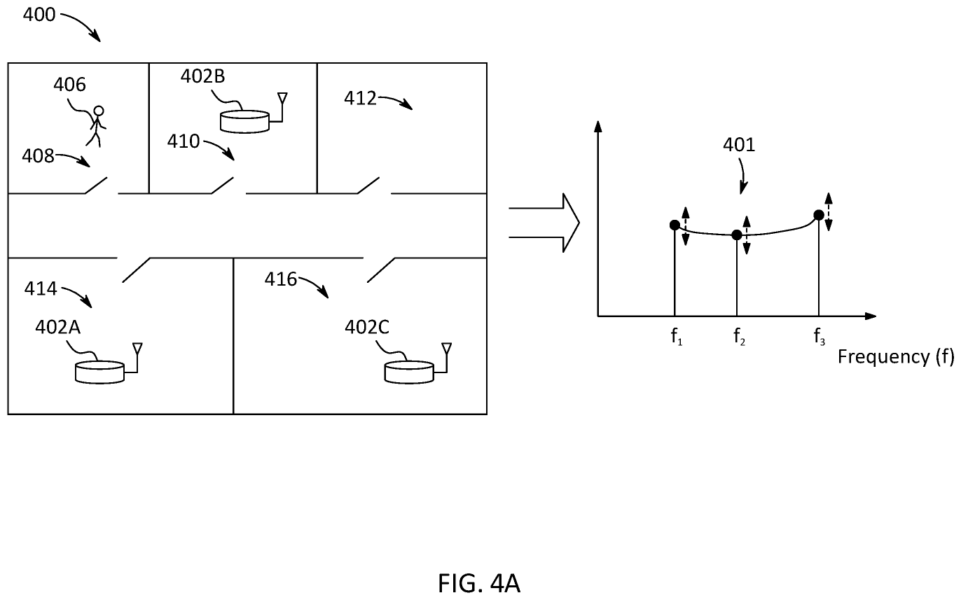

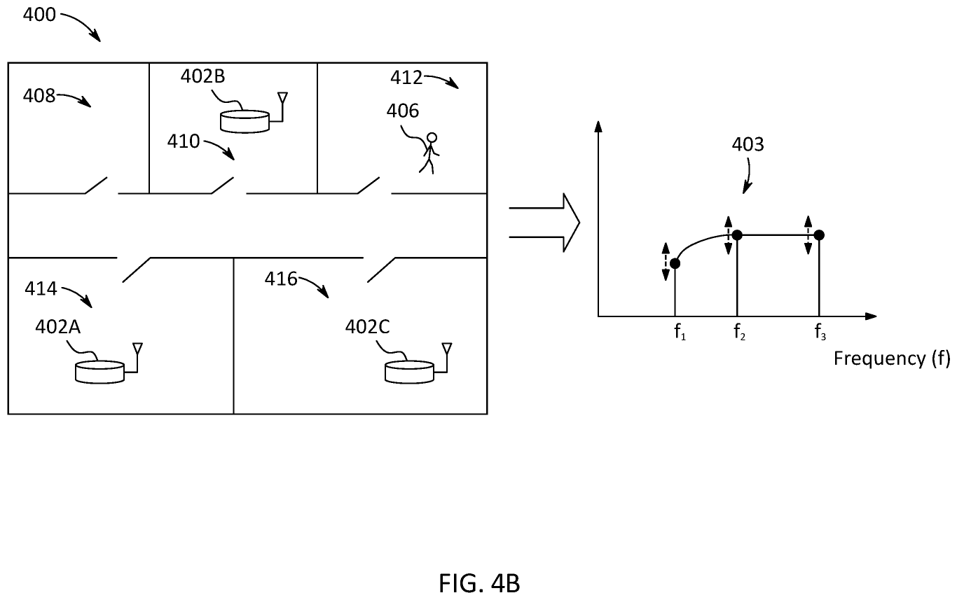

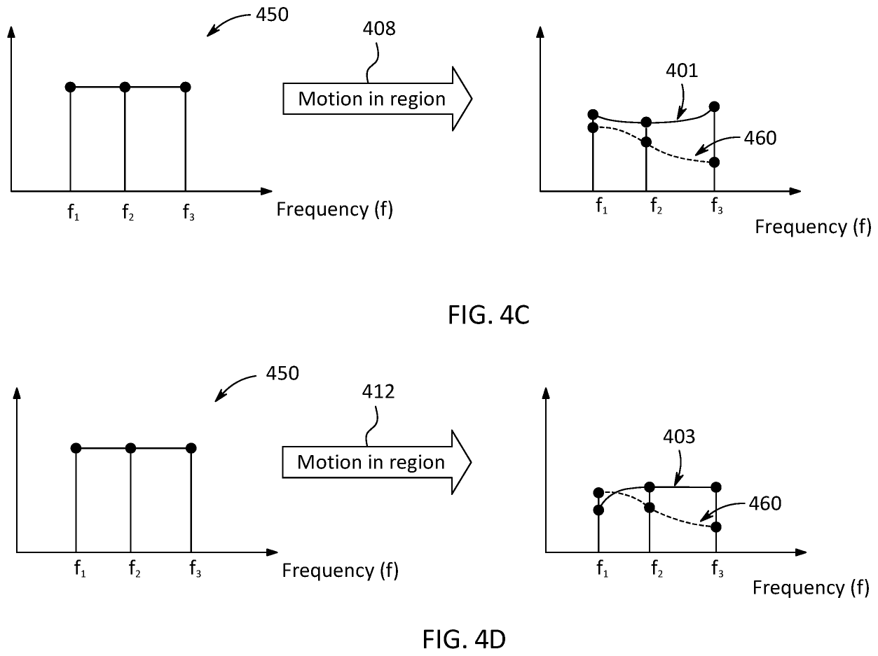

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions—first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of each frequency component f1, f2, and f3. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. FIGS. 4C-4D also show frequency domain representation 450 of an initial wireless signal transmitted by one or more of wireless communication devices 402A, 402B, 402C. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained AI model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each frequency component f1, f2, and f3 is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component f2 is less than the outer frequency components f1 and f3), while channel response 403 has a convex-asymptotic frequency profile (the magnitude of the middle frequency component f2 is greater than the outer frequency components f1 and f3). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an artificial intelligence (AI) model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentration of values into separate clusters, while the second layer combines some of these clusters together to create a category for a distinct region. Additional, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configurated to send sensing transmissions and make sensing measurements.

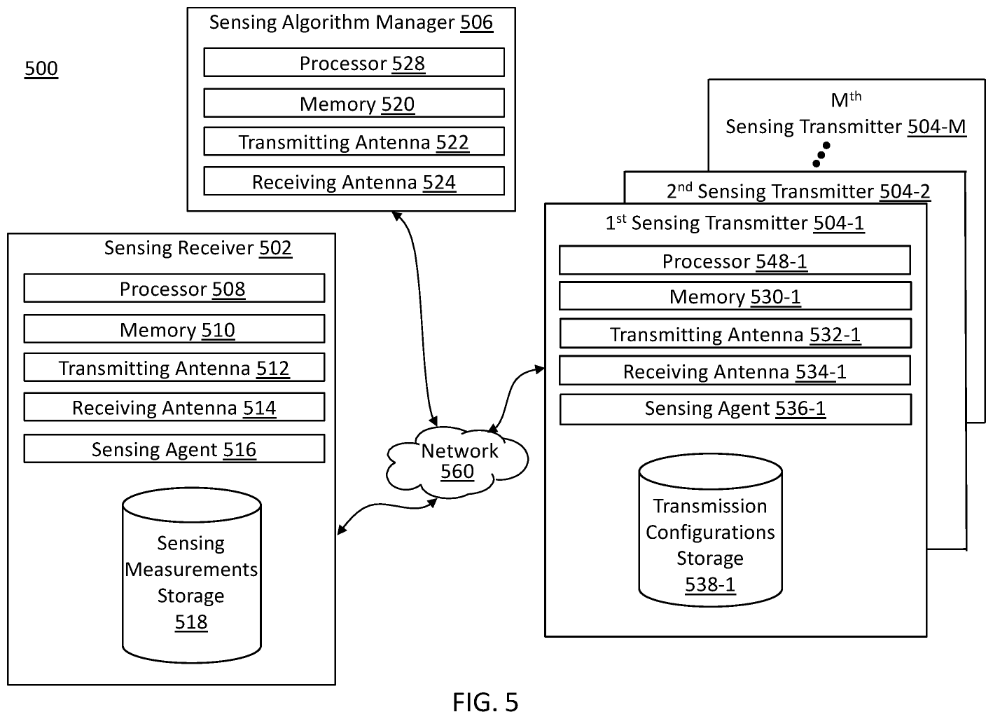

FIG. 5 depicts an implementation of some of an architecture of an implementation of system 500 for Wi-Fi sensing, according to some embodiments.

System 500 may include sensing receiver 502, plurality of sensing transmitters 504-(1-M), sensing algorithm manager 506, and network 560 enabling communication between the system components for information exchange. In an example implementation, plurality of sensing transmitters 504-(1-M) may include at least first sensing transmitter 504-1 and second sensing transmitter 504-2. System 500 may be an example or instance of wireless communication system 100 and network 560 may be an example or instance of wireless network or cellular network, details of which are provided with reference to FIG. 1 and its accompanying description.

According to an embodiment, sensing receiver 502 may be configured to receive a sensing transmission (for example, from each of plurality of sensing transmitters 504-(1-M)), and perform one or more measurements (for example, CSI) useful for Wi-Fi sensing. These measurements may be known as sensing measurements. The sensing measurements may be processed to achieve a sensing goal of system 500. In an embodiment, sensing receiver 502 may be an Access Point (AP). In some embodiments, sensing receiver 502 may take a role of sensing initiator.

According to an implementation, sensing receiver 502 may be implemented by a device, such as wireless communication device 102 shown in FIG. 1. In some implementations, sensing receiver 502 may be implemented by a device, such as wireless communication device 204 shown in FIG. 2A and FIG. 2B. Further, sensing receiver 502 may be implemented by a device, such as wireless communication device 402 shown in FIG. 4A and FIG. 4B. In an implementation, sensing receiver 502 may coordinate and control communication among plurality of sensing transmitters 504-(1-M). According to an implementation, sensing receiver 502 may be enabled to control a measurement campaign to ensure that required sensing transmissions are made at a required time and to ensure an accurate determination of sensing measurement. In some embodiments, sensing receiver 502 may process sensing measurements to achieve the sensing goal of system 500. In some embodiments, sensing receiver 502 may be configured to transmit sensing measurements to sensing algorithm manager 506, and sensing algorithm manager 506 may be configured to process the sensing measurements to achieve the sensing goal of system 500.

Referring again to FIG. 5, in some embodiments, each of plurality of sensing transmitters 504-(1-M) may form a part of a Basic Service Set (BSS) and may be configured to send a sensing transmission to sensing receiver 502 based on which, one or more sensing measurements (for example, CSI) may be performed for Wi-Fi sensing. In an embodiment, each of plurality of sensing transmitters 504-(1-M) may be a station (STA). According to an implementation, each of plurality of sensing transmitters 504-(1-M) may be implemented by a device, such as wireless communication device 102 shown in FIG. 1. In some implementations, each of plurality of sensing transmitters 504-(1-M) may be implemented by a device, such as wireless communication device 204 shown in FIG. 2A and FIG. 2B. Further, each of plurality of sensing transmitters 504-(1-M) may be implemented by a device, such as wireless communication device 402 shown in FIG. 4A and FIG. 4B. In some implementations, communication between sensing receiver 502 and each of plurality of sensing transmitters 504-(1-M) may happen via Station Management Entity (SME) and MAC Layer Management Entity (MLME) protocols.

In some embodiments, sensing algorithm manager 506 may be configured to receive sensing measurements from sensing receiver 502 and process the sensing measurements. In an example, sensing algorithm manager 506 may process and analyze the sensing measurements to identify one or more features of interest. According to some implementations, sensing algorithm manager 506 may include/execute a sensing algorithm. In an embodiment, sensing algorithm manager 506 may be a station. In some embodiments, sensing algorithm manager 506 may be an AP. According to an implementation, sensing algorithm manager 506 may be implemented by a device, such as wireless communication device 102 shown in FIG. 1. In some implementations, sensing algorithm manager 506 may be implemented by a device, such as wireless communication device 204 shown in FIG. 2A and FIG. 2B. Further, sensing algorithm manager 506 may be implemented by a device, such as wireless communication device 402 shown in FIG. 4A and FIG. 4B. In some embodiments, sensing algorithm manager 506 may be any computing device, such as a desktop computer, a laptop, a tablet computer, a mobile device, a Personal Digital Assistant (PDA) or any other computing device. In embodiments, sensing algorithm manager 506 may take a role of sensing initiator where a sensing algorithm determines a measurement campaign and the sensing measurements required to fulfill the measurement campaign. Sensing algorithm manager 506 may communicate the sensing measurements required to fulfill the measurement campaign to sensing receiver 502 to coordinate and control communication among plurality of sensing transmitters 504-(1-M).

Referring to FIG. 5, in more detail, sensing receiver 502 may include processor 508 and memory 510. For example, processor 508 and memory 510 of sensing receiver 502 may be processor 114 and memory 116, respectively, as shown in FIG. 1. In an embodiment, sensing receiver 502 may further include transmitting antenna(s) 512, receiving antenna(s) 514, and sensing agent 516. In some embodiments, an antenna may be used to both transmit and receive signals in a half-duplex format. When the antenna is transmitting, it may be referred to as transmitting antenna 512, and when the antenna is receiving, it may be referred to as receiving antenna 514. It is understood by a person of normal skill in the art that the same antenna may be transmitting antenna 512 in some instances and receiving antenna 514 in other instances. In the case of an antenna array, one or more antenna elements may be used to transmit or receive a signal, for example, in a beamforming environment. In some examples, a group of antenna elements used to transmit a composite signal may be referred to as transmitting antenna 512, and a group of antenna elements used to receive a composite signal may be referred to as receiving antenna 514. In some examples, each antenna is equipped with its own transmission and receive paths, which may be alternately switched to connect to the antenna depending on whether the antenna is operating as transmitting antenna 512 or receiving antenna 514.

In an implementation, sensing agent 516 may be responsible for receiving sensing transmissions and associated transmission parameters, calculating sensing measurements, and processing sensing measurements to fulfill a sensing goal. In some implementations, receiving sensing transmissions and associated transmission parameters, and calculating sensing measurements may be carried out by an algorithm running in the Medium Access Control (MAC) layer of sensing receiver 502 and processing sensing measurements in to fulfill a sensing goal may be carried out by an algorithm running in the application layer of sensing receiver 502. In examples, the algorithm running in the application layer of sensing receiver 502 is known as Wi-Fi sensing agent, sensing application, or sensing algorithm. In some implementations, the algorithm running in the MAC layer of sensing receiver 502 and the algorithm running in the application layer of sensing receiver 502 may run separately on processor 508. In an implementation, sensing agent 516 may pass physical layer parameters (e.g., such as CSI) from the MAC layer of sensing receiver 502 to the application layer of sensing receiver 502 and may use the physical layer parameters to detect one or more features of interest. In an example, the application layer may operate on the physical layer parameters and form services or features, which may be presented to an end-user. According to an implementation, communication between the MAC layer of sensing receiver 502 and other layers or components may take place based on communication interfaces, such as MLME interface and a data interface. According to some implementations, sensing agent 516 may include/execute a sensing algorithm. In an implementation, sensing agent 516 may process and analyze sensing measurements using the sensing algorithm, and identify one or more features of interest. Further, sensing agent 516 may be configured to determine a number and timing of sensing transmissions and sensing measurements for the purpose of Wi-Fi sensing. In some implementations, sensing agent 516 may be configured to transmit sensing measurements to sensing algorithm manager 506 for further processing.

In an implementation, sensing agent 516 may be configured to cause at least one transmitting antenna of transmitting antenna(s) 512 to transmit messages to plurality of sensing transmitters 504-(1-M). Further, sensing agent 516 may be configured to receive, via at least one receiving antenna of receiving antennas(s) 514, messages from plurality of sensing transmitters 504-(1-M). In an example, sensing agent 516 may be configured to make sensing measurements based on sensing transmissions received from plurality of sensing transmitters 504-(1-M). According to an implementation, sensing agent 516 may be configured to process and analyze the sensing measurements to identify one or more features of interest.

In some embodiments, sensing receiver 502 may include sensing measurements storage 518. In an implementation, sensing measurements storage 518 may store sensing measurements computed by sensing receiver 502 based on sensing transmissions received from plurality of sensing transmitters 504-(1-M). In an example implementation, the sensing measurements storage 518 may store CSI values and assembled channel state information (A-CSI) values associated with plurality of sensing transmitters 504-(1-M). Information related to the sensing measurements stored in sensing measurements storage 518 may be periodically or dynamically updated as required. In an implementation, sensing measurements storage 518 may include any type or form of storage, such as a database or a file system or coupled to memory 510.

Although sensing algorithm manager 506 is shown in FIG. 5 as a functional block separate from sensing receiver 502 and plurality of sensing transmitters 504-(1-M), in an embodiment of system 500, sensing algorithm manager 506 may be implemented by either sensing receiver 502 or one of plurality of sensing transmitters 504-(1-M). Although sensing algorithm manager 506 is shown as a single functional block, in one implementation there may be one or more sensing algorithm managers, in an embodiment of system 500.

Referring again to FIG. 5, first sensing transmitter 504-1 may include processor 548-1 and memory 530-1. For example, processor 548-1 and memory 530-1 of first sensing transmitter 504-1 may be processor 114 and memory 116, respectively, as shown in FIG. 1. In an embodiment, first sensing transmitter 504-1 may further include transmitting antenna(s) 532-1, receiving antenna(s) 534-1, and sensing agent 536-1. In an implementation, sensing agent 536-1 may be a block that passes physical layer parameters from the MAC of first sensing transmitter 504-1 to application layer programs. Sensing agent 536-1 may be configured to cause at least one transmitting antenna of transmitting antenna(s) 532-1 and at least one receiving antenna of receiving antennas(s) 534-1 to exchange messages with sensing receiver 502. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In some embodiments, first sensing transmitter 504-1 may include transmission configurations storage 538-1. Transmission configurations storage 538-1 may store requested transmission configuration requested by sensing receiver 502 to first sensing transmitter 504-1 or delivered transmission configuration delivered by first sensing transmitter 504-1 to sensing receiver 502. Information regarding transmission configurations stored in transmission configurations storage 538-1 may be periodically or dynamically updated as required. In an implementation, transmission configurations storage 538-1 may include any type or form of storage, such as a database or a file system or coupled to memory 530-1.

For ease of explanation and understanding, the description provided above is with reference to first sensing transmitter 504-1, however, the description is equally applicable to remaining sensing transmitters 504-(2-M).

Referring again to FIG. 5, sensing algorithm manager 506 may include processor 528 and memory 520. For example, processor 528 and memory 520 of sensing algorithm manager 506 may be processor 114 and memory 116, respectively, as shown in FIG. 1. In an embodiment, sensing algorithm manager 506 may further include transmitting antenna(s) 522, and receiving antenna(s) 524. In some embodiments, an antenna may be used to both transmit and receive signals in a half-duplex format. When the antenna is transmitting, it may be referred to as transmitting antenna 522, and when the antenna is receiving, it may be referred to as receiving antenna 524. It is understood by a person of normal skill in the art that the same antenna may be transmitting antenna 522 in some instances and receiving antenna 524 in other instances. In the case of an antenna array, one or more antenna elements may be used to transmit or receive a signal, for example, in a beamforming environment. In some examples, a group of antenna elements used to transmit a composite signal may be referred to as transmitting antenna 522, and a group of antenna elements used to receive a composite signal may be referred to as receiving antenna 524. In some examples, each antenna is equipped with its own transmission and receive paths, which may be alternately switched to connect to the antenna depending on whether the antenna is operating as transmitting antenna 522 or receiving antenna 524.

In an implementation sensing algorithm manager 506 may include sensing agent 516, previously described in sensing receiver 502.

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax adopted OFDMA, which allows sensing receiver 502 to simultaneously transmit data to all participating devices, such as plurality of sensing transmitters 504-(1-M), and vice versa using a single TXOP. The efficiency of OFDMA depends on how sensing receiver 502 schedules channel resources (interchangeably referred to as resource units (RUs)) among plurality of sensing transmitters 504-(1-M) and configures transmission parameters. According to an implementation, system 500 may be an OFDMA 802.11ax enabled system.

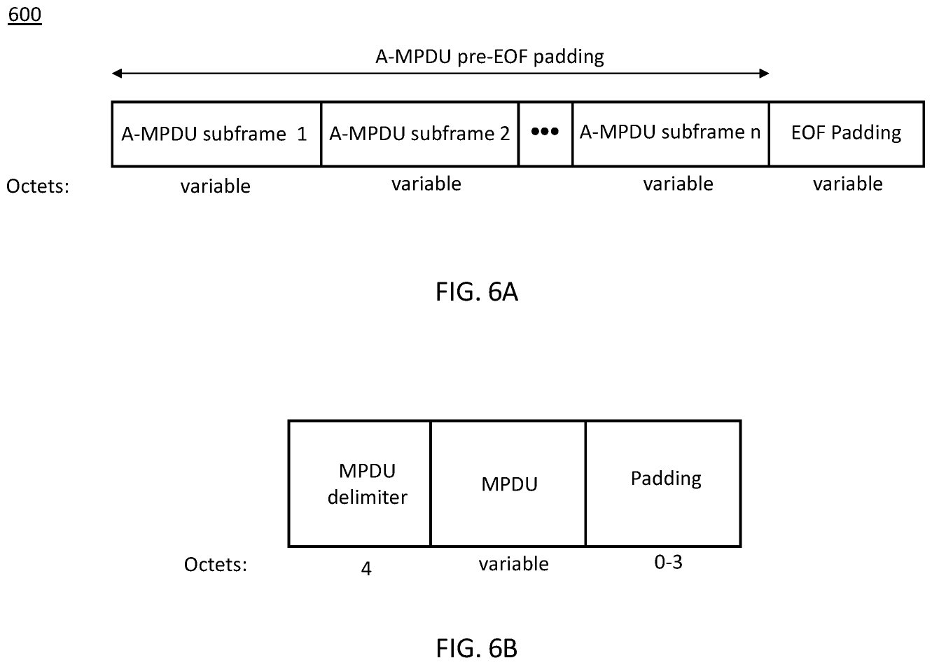

The IEEE 802.11 standard defines two types of frame aggregation: A-MPDU aggregation and A-MSDU aggregation. Frame aggregation allows for multiple MPDUs or MSDUs to be carried in the same PPDU thereby saving the overhead of transmitting and receiving multiple PPDUs. In an implementation, a measurement campaign may depend on data carried within a frame header and so frames are aggregated using A-MPDU. FIG. 6A describes a structure of an A-MPDU frame and FIG. 6B describes a structure of an A-MPDU subframe according to IEEE 602.11. As shown in FIG. 6A, the A-MPDU includes a sequence of one or more A-MPDU subframes and a variable amount of End of Frame (EOF) padding. Further, as shown in FIG. 6B, in A-MPDU subframe, an MPDU delimiter is prepended to an MPDU and padding are appended to the MPDU.

According to one or more implementations, uplink orthogonal frequency division multiple access (UL-OFDMA) may be used to assign bandwidth for plurality of sensing transmitters 504-(1-M) to make uplink (i.e., from a sensing transmitter to a sensing receiver) sensing transmissions. According to an implementation, sensing receiver 502 may secure a TXOP which may be allocated to the uplink sensing transmissions by plurality of sensing transmitters 504-(1-M). In an implementation, sensing receiver 502 may assign multiple component bands of a wideband signal in the secured TXOP to plurality of sensing transmitters 504-(1-M) for simultaneous uplink sensing transmissions.

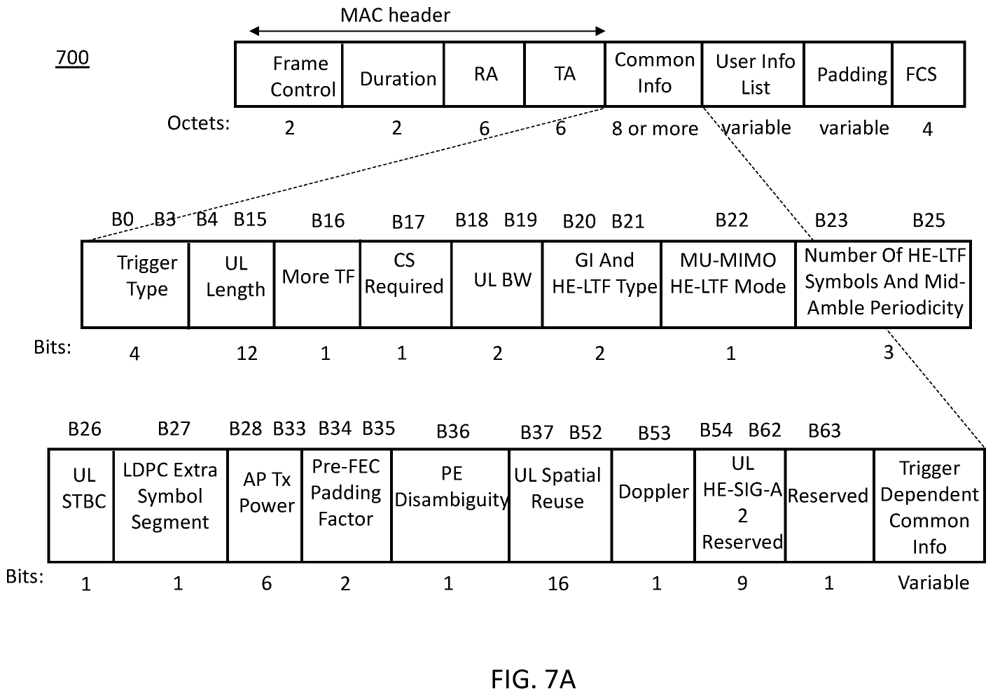

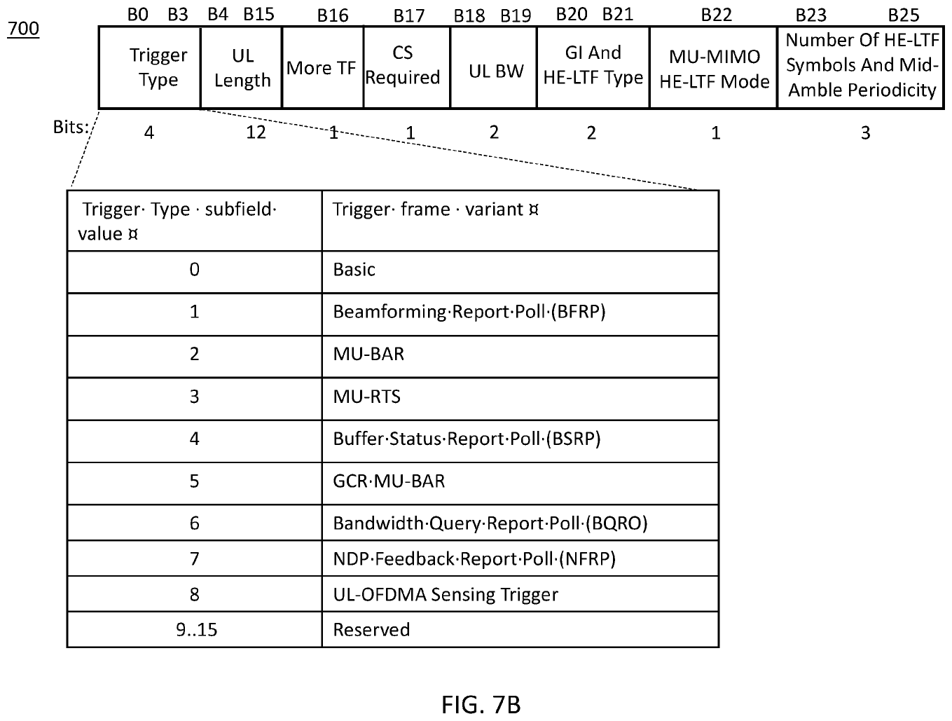

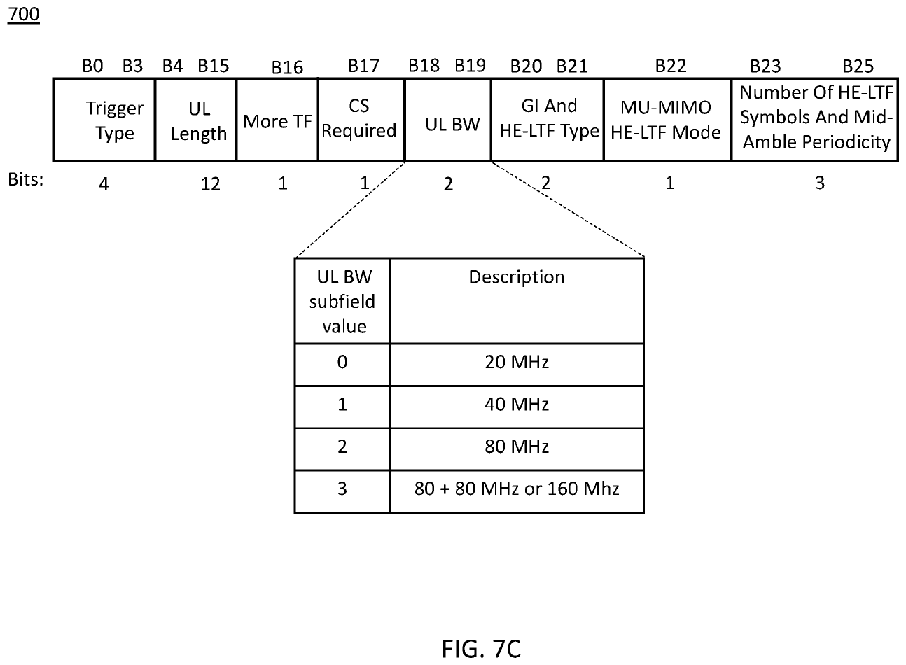

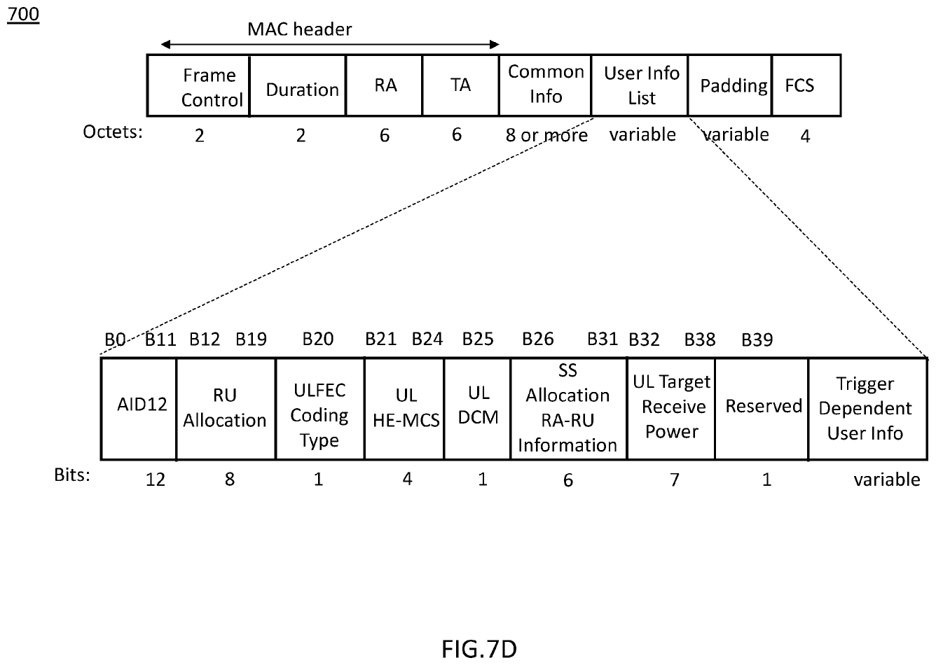

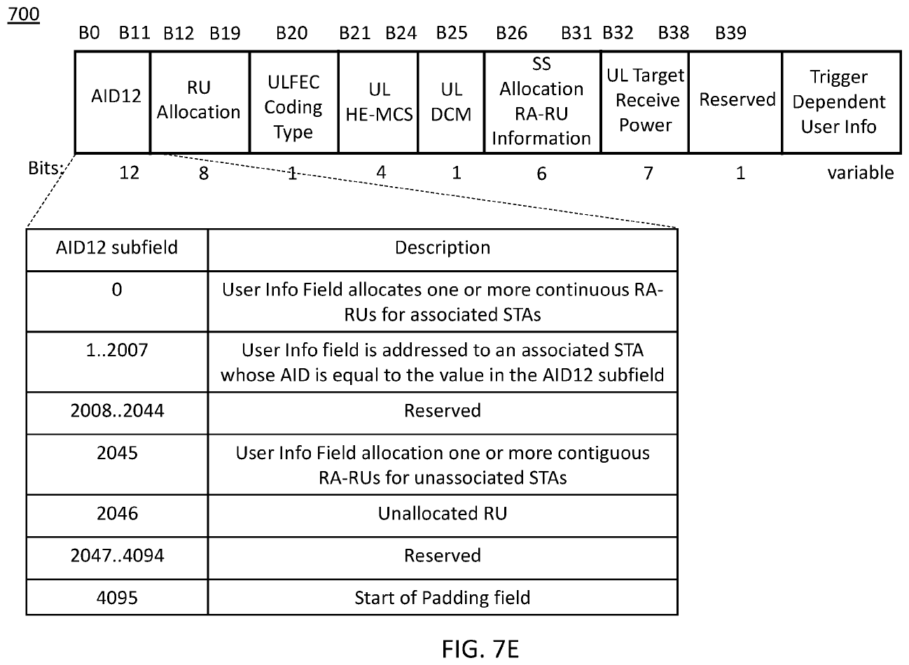

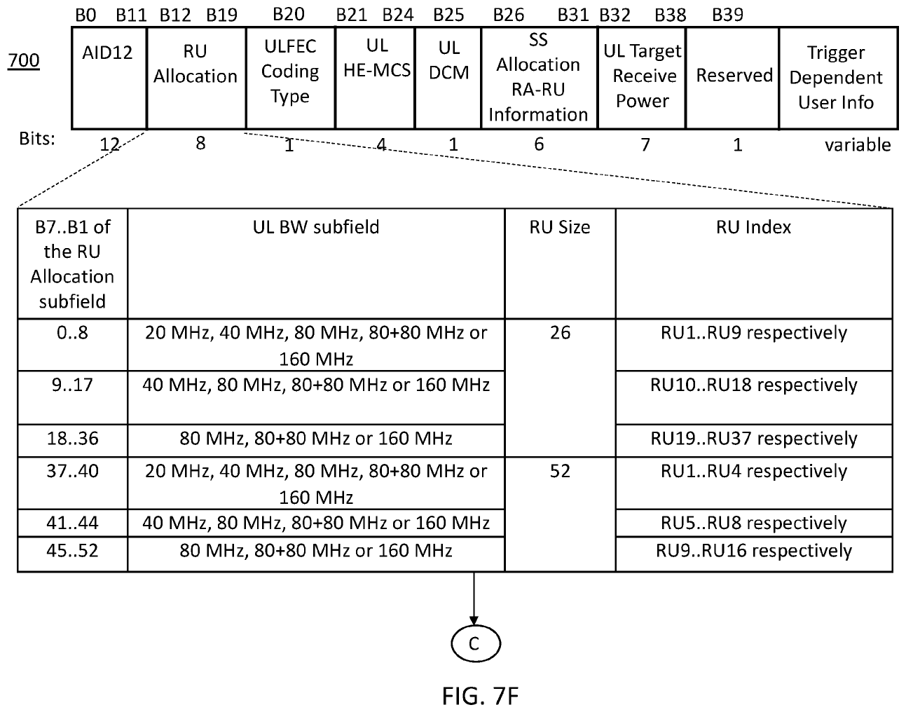

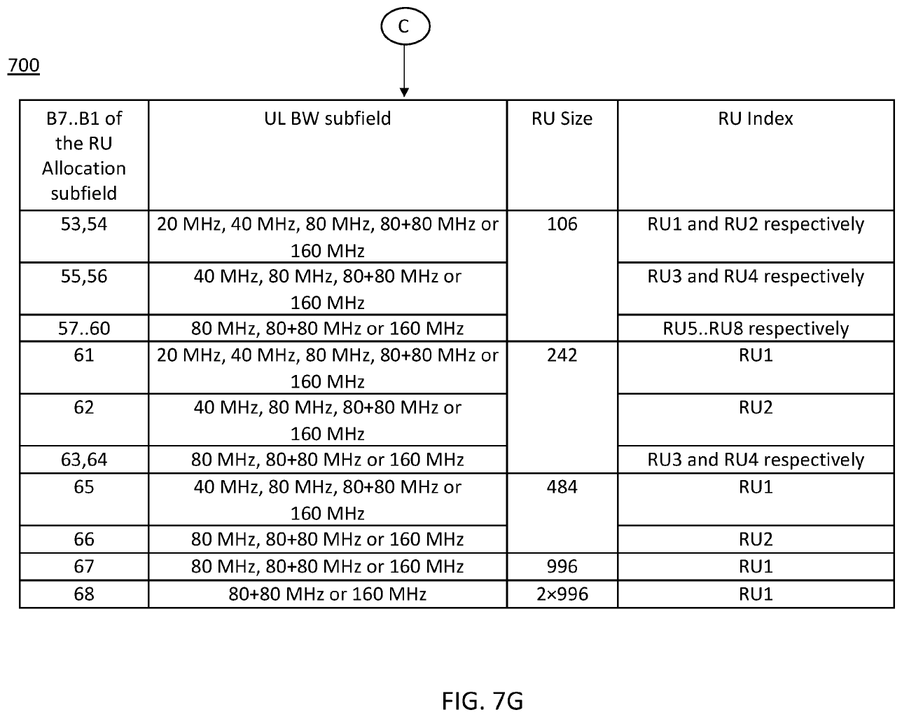

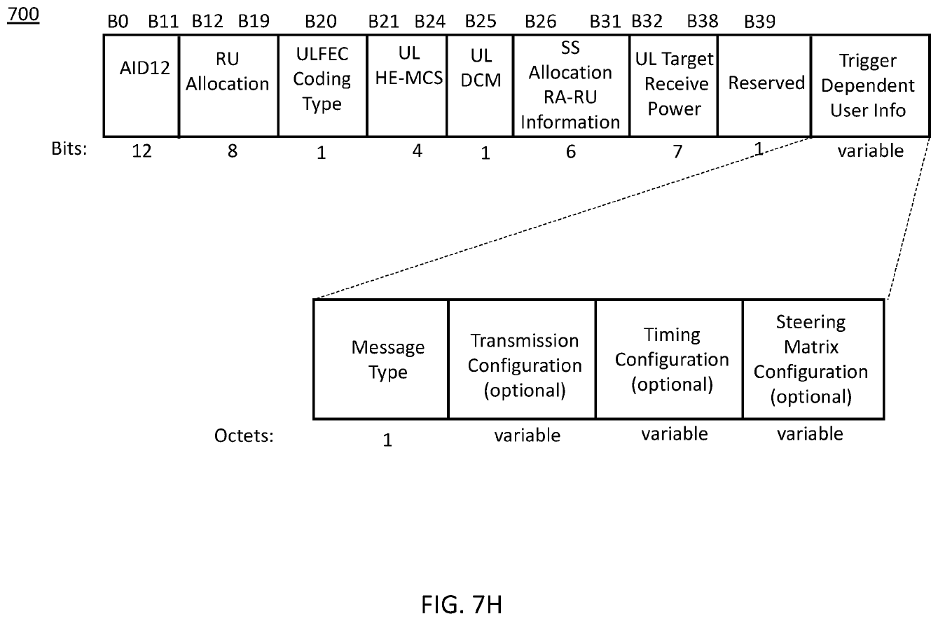

According to an implementation, hierarchy of the fields within a trigger frame 700 is shown in FIG. 7A to FIG. 7H. The trigger frame may interchangeably be referred to as UL-OFDMA sensing trigger message.

As described in FIG. 7A, the Common Info field contains information which is common to plurality of sensing transmitters 504-(1-M). As described in FIG. 7B, a new Trigger Type (bits B0 to B3 of “Common Info” field) may be defined which represents the UL-OFDMA sensing trigger message. The UL-OFDMA sensing trigger message may have a Trigger Type subfield value of 8.

As described in FIG. 7C the UL-OFDMA sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 7D, the User Info List contains information which is specific to each of plurality of sensing transmitters 504-(1-M).

As described in FIG. 7E, the AID12 subfield may be used to address a specific sensing transmitter of a plurality of sensing transmitters 504-(1-M).

As described in FIG. 7F and FIG. 7G, the RU Allocation subfield is used to allocate resource units (RU) to each of plurality of sensing transmitters 504-(1-M).

As described in FIG. 7H, the Trigger Dependent User Info subfield may be used to request the transmission configuration and/or steering matrix configuration for each of plurality of sensing transmitters 504-(1-M) that the UL-OFDMA sensing trigger message is triggering. C. Methods and Systems for time spread assembled CSI for wideband channels

The present disclosure generally relates to systems and methods for Wi-Fi sensing. In particular, the present disclosure relates to systems and methods for time spread assembled channel state information (A-CSI) for wideband channels.

According to one or more implementations, wideband channel, includes 40 MHz wideband channel, 80 MHz wideband channel, and 160 MHz wideband channel and are supported by IEEE 802.11 standard. Other bandwidths which are not specified and supported by IEEE 802.11 standard but may be specified and supported at a future time may also be represented by the definition, wideband channel. Each of the 40 MHz wideband channel, 80 MHz wideband channel, and 160 MHz wideband channel respectively occupies two, four, and eight contiguous 20 MHz component bands. However, creating wideband channels in this way is possible only when multiple contiguous 20 MHz component bands are available. There may be scenarios where no sufficient contiguous 20 MHz component bands are available to constitute a wideband channel.

According to an implementation, movement or motion may be detected by analyzing channel representation information (CRI) (for example, CSI) perturbances with respect to a steady state channel between a sensing transmitter and a sensing receiver. In an example, each sensing transmitter and sensing receiver pair may represent a channel of interest in which motion may be detected.

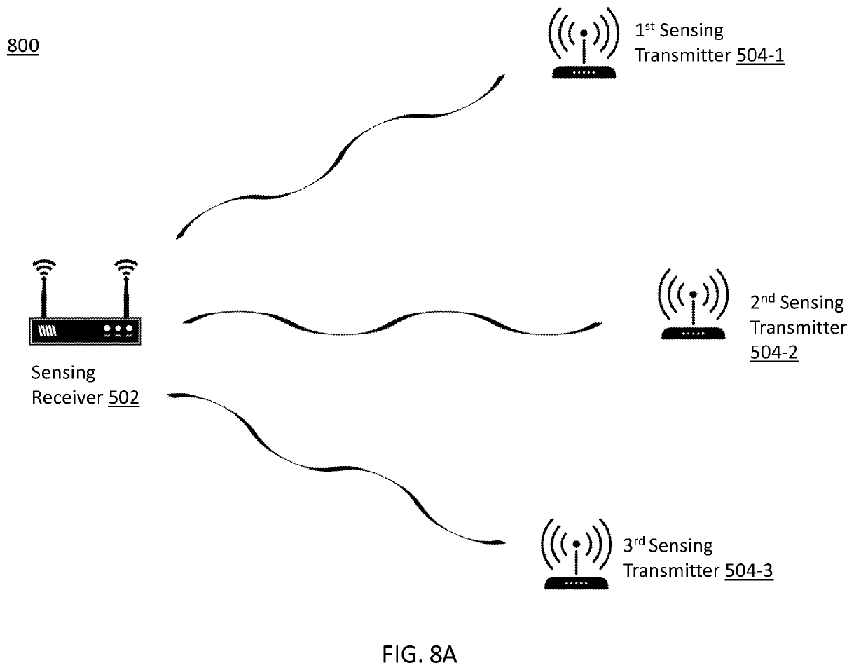

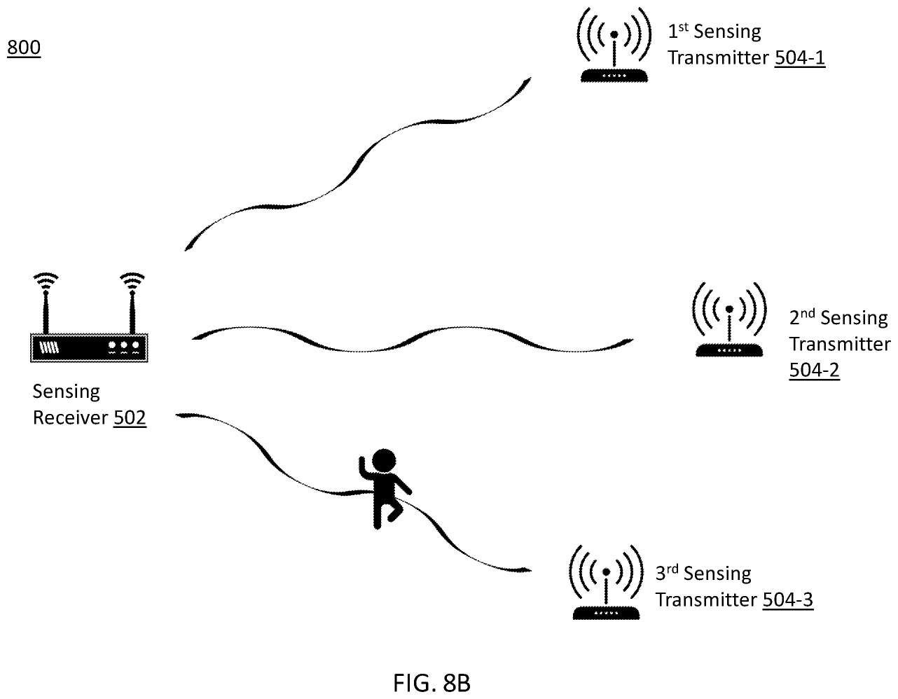

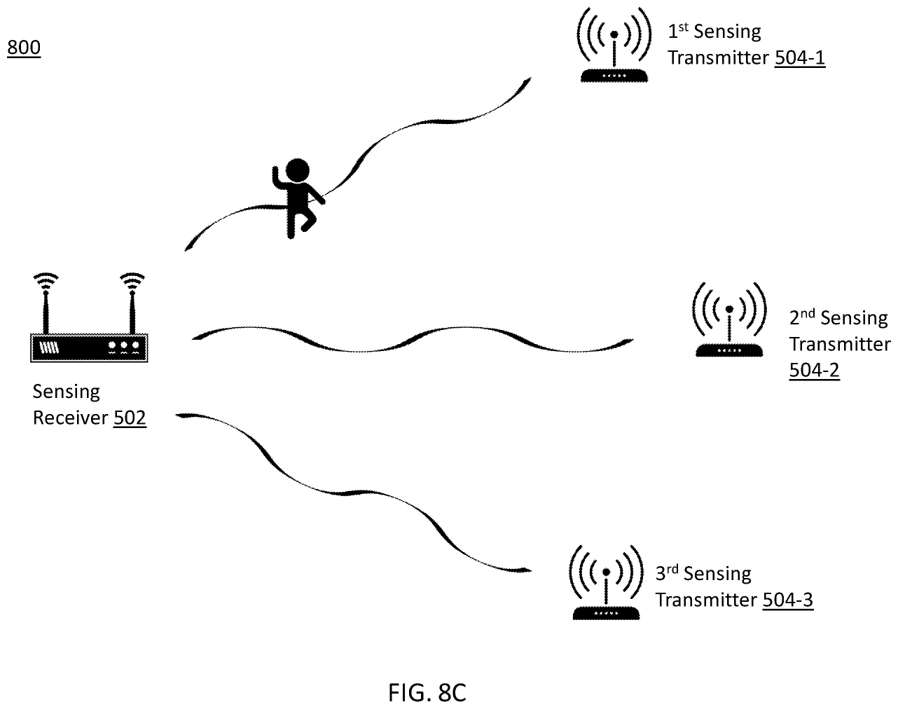

FIG. 8A depicts Wi-Fi sensing system 800 with three sensing transmitters and one sensing receiver, according to some embodiments.

As described in FIG. 8A, Wi-Fi sensing system 800 may include sensing receiver 504-1 and three sensing transmitters, namely, first sensing transmitter 504-1, second sensing transmitter 504-2, and third sensing transmitter 504-3. Any movement that may occur in the sensing space may be reflected in the CSI of the transmission channel between one or more of the sensing transmitters and the sensing receiver, depending on where in the sensing space the movement occurred.

FIG. 8B depicts channel perturbation impacting transmission paths between third sensing transmitter 504-3 and sensing receiver 502, according to some embodiments. As described in FIG. 8B. Movement or motion can be detected in sensing space of third sensing transmitter 804-3 and sensing receiver 502. The movement or motion may affect the transmission channel between third sensing transmitter 504-3 and sensing receiver 502 only.

FIG. 8C depicts channel perturbation impacting transmission paths between first sensing transmitter 504-1 and sensing receiver 502, according to some embodiments. As described in FIG. 8C, movement can be detected in sensing space of first sensing transmitter 804-1 and sensing receiver 502. The movement may affect the transmission channel between first sensing transmitter 804-1 and sensing receiver 502 only.

FIG. 8B and FIG. 8C indicate that only first sensing transmitter 504-1 and sensing receiver 502 pair, and third sensing transmitter 504-3 and sensing receiver 502 pair are relevant for motion detection. As the movement is detected by perturbances caused in a transmission channel, CSI representing only transmissions in the relevant transmission channels may be considered for motion detection.

Table 1 illustrates different channel bandwidths available in various versions of the IEEE 802.11 standard.

TABLE 1
IEEE802.11a/g/n/ac PHY Channel Bandwidths

| | | | | | Number of | |
|---|---|---|---|---|---|---|
| | | | | Number of | subcarriers | |
| | Bandwidth | Subcarrier | Number of | pilot | for data | IFFT |
| Standard | (MHz) | range | subcarriers | subcarriers | transmission | size |
| 802.11a/g | 20 | −26 to −1, | 52 | 4 | 48 | 64 |
| | | +1 to +26 | | | | |
| 802.11n/ac | 20 | −28 to −1, | 56 | 4 | 52 | 64 |
| | | +1 to +28 | | | | |
| 802.11ac | 40 | −58 to −2, | 114 | 6 | 108 | 128 |
| | | +2 to +58 | | | | |
| | 80 | −112 to −2, | 242 | 8 | 234 | 256 |
| | | +2 to +112 | | | | |
| | 160 | −250 to −130, | 484 | 16 | 468 | 512 |
| | | −126 to −6, | | | | |
| | | +6 to +126, | | | | |
| | | +130 to +250 | | | | |

In an 802.11 ac or newer system that utilizes 20 MHz, 80 MHz, or 160 MHz channel bandwidths, it may be beneficial if the entire bandwidth could be used for a sensing transmission from a sensing transmitter to a sensing receiver. As described earlier, UL-OFDNVIA introduces the ability to share the uplink bandwidth between multiple sensing transmitters in the same TXOP. Accordingly, in system 500, signals may be transmitted from multiple sensing transmitters.

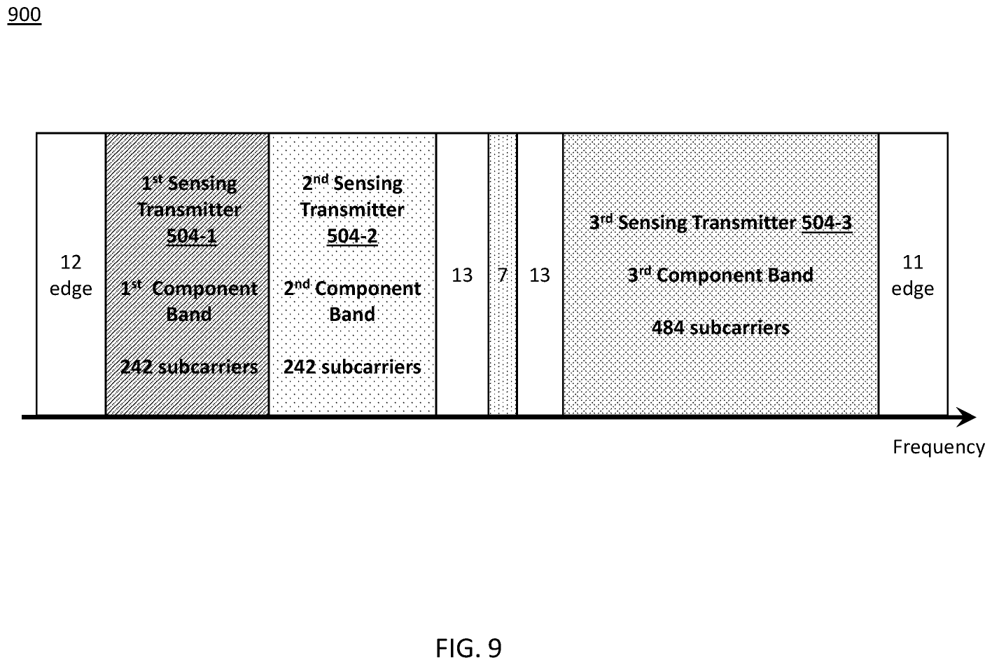

FIG. 9 depicts example 900 of allocation of an 80 MHz channel bandwidth into component bands assigned to three sensing transmitters in a single TXOP, according to some embodiments. As described in FIG. 9, 80 MHz channel bandwidth may be divided into multiple (three in example 900) component bands, namely, first component band, second component band, and third component band. The first component band, the second component band, and the third component band are assigned to first sensing transmitter 504-1, second sensing transmitter 504-2, and third sensing transmitter 504-3, respectively. In an example, the first component band and the second component band have 242 subcarriers each, and the third component band has 484 subcarriers Further, the first component band with 242 subcarriers may have 20 MHz bandwidth. The second component band with 242 subcarriers may have 20 MHz bandwidth. The third component band with 484 subcarriers may have 40 MHz bandwidth. The sensing receiver 502 may receive a sensing transmission from each of first sensing transmitter 504-1, second sensing transmitter 504-2, and third sensing transmitter 504-3 within 80 MHz channel bandwidth and collects CSI associated with each of first sensing transmitter 504-1, second sensing transmitter 504-2, and third sensing transmitter 504-3. FIG. 9 also shows 7 subcarriers in the center which are DC tones as well as a further, 13 subcarriers on either side of the 7 subcarriers, 12 edge subcarriers, and 11 edge subcarriers which are unused for the uplink sensing transmission received by sensing receiver 502.

Referring to FIG. 5, according to one or more implementations, for the purpose of Wi-Fi sensing, sensing receiver 502 may initiate a measurement campaign (or a Wi-Fi sensing session). In the measurement campaign, exchange of transmissions between sensing receiver 502 and plurality of sensing transmitter 504-(1-M) may occur. In an example, control of these transmissions may be by the MAC layer of the IEEE 802.11 stack.

According to an implementation, sensing agent 516 may initially determine a time window. The time window may be denoted by TA. The time window may be of a predetermined length of time. In an implementation, the time window may be configured to encompass a predetermined number of transmission opportunity periods. During each of the predetermined number of transmission opportunity periods, sensing receiver 502 may receive one sensing transmission from one sensing transmitter.

In an implementation, sensing agent 516 may be configured to generate a sensing trigger message configured to trigger a series of sensing transmissions from plurality of sensing transmitters 504-(1-M). The series of sensing transmissions may include a sensing transmission from each of plurality of sensing transmitters 504-(1-M). In an example, the sensing trigger message may be an UL-OFDMA sensing trigger message which may instruct plurality of sensing transmitters 504-(1-M) to make sensing transmissions using UL-OFDMA. In an example, the sensing trigger message may include a requested transmission configuration field. Other examples of information/data included in the sensing trigger message that are not discussed here are contemplated herein.

According to an implementation, sensing agent 516 may transmit the sensing trigger message to plurality of sensing transmitters 504-(1-M). In an implementation, sensing agent 516 may transmit the sensing trigger message to plurality of sensing transmitters 504-(1-M) via transmitting antenna 512 to trigger the series of sensing transmissions from plurality of sensing transmitters 504-(1-M).

In response to receiving the sensing trigger message, each of plurality of sensing transmitters 504-(1-M) may generate a plurality of sensing transmissions. In an example, the plurality of sensing transmissions that the sensing trigger message triggers from each of plurality of sensing transmitters 504-(1-M) may be a sensing response message. In an implementation, each of plurality of sensing transmitters 504-(1-M) may generate the plurality of sensing transmissions using the requested transmission configuration. According to an implementation, each of plurality of sensing transmitters 504-(1-M) may transmit respective sensing transmissions to sensing receiver 502 in response to the sensing trigger message and in accordance with the requested transmission configuration. In an example, each sensing transmission may include a delivered transmission configuration corresponding to the transmission configuration used to deliver the sensing transmission. In an example, when it may be supported by the sensing transmitter the delivered transmission configuration corresponds to the requested transmission configuration.

In an implementation, sensing receiver 502 may receive a plurality of sensing transmissions from a sensing transmitter in the time window. In an example implementation, sensing receiver 502 may receive the plurality of sensing transmissions from first sensing transmitter 504-1. In response to receiving the plurality of sensing transmissions, sensing agent 516 may generate CSI in a frequency domain based on the plurality of sensing transmissions. In an implementation, sensing agent 516 may generate a plurality of sensing measurements representing the CSI based on the plurality of sensing transmissions. According to an implementation, sensing agent 516 may identify selected CSI from among the corresponding CSI. In an example, sensing agent 516 may identify the corresponding CSI associated with the sensing transmissions associated with contiguous component bands from the sensing transmitter as the selected CSI.

In some implementations, sensing agent 516 may identify, as first selected CSI, the corresponding CSI associated with the sensing transmissions associated with first contiguous component bands from the sensing transmitter. Further, sensing agent 516 may identify, as second selected CSI, the corresponding CSI associated with the sensing transmissions associated with second contiguous component bands from the sensing transmitter.

According to some implementations, sensing agent 516 may identify the selected CSI based on determining that corresponding CSI associated with a first sensing transmission of the plurality of sensing transmissions and corresponding CSI associated with a second sensing transmission of the plurality of sensing transmissions are associated with same component bands from the sensing transmitter, and including the corresponding CSI associated with the second sensing transmission in the selected CSI and excluding the CSI associated with the first sensing transmission in the selected CSI. In an example, the second sensing transmission may be received later in time than the first sensing transmission.

According to some implementations, sensing agent 516 may identify the selected CSI based on determining that corresponding CSI associated with the first sensing transmission of the plurality of sensing transmissions and corresponding CSI associated with the second sensing transmission of the plurality of sensing transmissions are associated with same component bands from the sensing transmitter, where the second sensing transmission is received later in time than the first sensing transmission, combining the corresponding CSI associated with the first sensing transmission and the CSI associated with the second sensing transmission, and including the combined CSI in the selected CSI.

Further, sensing agent 516 may be configured to combine the selected CSI to generate A-CSI. In an implementation, sensing agent 516 may generate time domain channel representation information (TD-CRI) of the A-CSI to minimize the amount of information that is sent to sensing algorithm manager 506. Sensing agent 516 may then send information representative of the A-CSI to sensing algorithm manager 506. In an example, the information representative of the A-CSI may include the A-CSI. In some examples, the information representative of the A-CSI may include the TD-CRI.

According to some implementations, sensing agent 516 may receive a subsequent sensing transmission from the sensing transmitter after the time window. Upon receiving the subsequent sensing transmission from the sensing transmitter, sensing agent 516 may shift the time window to include the subsequent sensing transmission and a portion of the plurality of sensing transmissions. Sensing agent 516 may then generate a subsequent CSI based on the subsequent sensing transmission and combine the subsequent CSI with a portion of the selected CSI to generate subsequent A-CSI. In some implementations, sensing agent 516 may receive a subsequent sensing transmission after the time window and determine a subsequent time window configured to encompass a plurality of subsequent transmissions received after the time window.

In some implementations, sensing agent 516 may be configured to receive a first plurality of sensing transmissions from first sensing transmitter 504-1 in the time window and a second plurality of sensing transmissions from second sensing transmitter 504-2 in the time window. Sensing agent 516 may be configured to generate a plurality of sensing measurements representing CSI based on the first plurality of sensing transmissions and the second plurality of sensing transmissions. In an example, the plurality of sensing measurements generated corresponding to the first plurality of sensing transmissions may be referred to as first plurality of sensing measurements and the plurality of sensing measurements generated corresponding to the second plurality of sensing transmissions may be referred to as second plurality of sensing measurements. Sensing agent 516 may generate the CSI based on the first plurality of sensing transmissions and the second plurality of sensing transmissions. In an example, each of the first plurality of sensing measurements may have corresponding CSI and each of the second plurality of sensing measurements may have corresponding CSI. Further, sensing agent 516 may be configured to identify, as a first selected CSI, the corresponding CSI associated with first sensing transmissions associated with contiguous component bands from first sensing transmitter 504-1 and identify, as a second selected CSI, the corresponding CSI associated with second sensing transmissions associated with contiguous component bands from second sensing transmitter 504-2. Sensing agent 516 may then combine the first selected CSI to generate first A-CSI and combine the second selected CSI to generate second A-CSI. Further sensing agent 516 may send first information representative of the first A-CSI and second information representative of the second A-CSI to sensing algorithm manager 506. The manner in which A-CSI is generated and sent to sensing algorithm manager 506 is described in greater detail below.

According to an implementation, the aspects of the present disclosure may be applied when TXOP may be limited to zero. In some implementations, the aspects of the present disclosure may be applied for non-zero TXOP limits, and instead of referring to the number of TXOPs of single frame sensing transmissions, it would then apply to the number of frames the sensing transmitter transmits in its TXOP.

In an implementation, for processing and analyzing a wideband CSI (i.e., a CSI that is wider than the component band of a sensing transmitter in a single TXOP) associated with a single sensing transmitter, sensing transmissions from that sensing transmitter spanning multiple TXOPs may be used. As described earlier, CSI are calculated on component bands in multiple TXOPs and are aggregated prior to processing by sensing algorithm manager 506. When CSI calculated on component bands transmitted by a specific sensing transmitter in multiple TXOPs are aggregated prior to processing, the A-CSI are characterized according to the identity of the sensing transmitter. Any identifier, associated with the sensing transmitter, which is unique to sensing algorithm manager 506, may be used to identify an A-CSI being associated with the particular sensing transmitter.

For sensing measurements that will be assembled to form A-CSI, there is permittable time delay which indicates maximum time permitted for CSI collection. In an example, motion detection based on CSI calculated on sensing transmissions that span multiple TXOPs may only be reliable if the delay between the first sensing transmission used and the last sensing transmission used in the A-CSI does not exceed the coherence time of the transmission channel. The maximum time permitted over which the CSI from sensing transmissions can be assembled is T_{A}. In an implementation, T_{A} may be same for all sensing transmitters/sensing receiver pairs that collectively span the sensing space. In some implementations, T_{A} may be different for each sensing transmitter/sensing receiver pair in the sensing space. In accordance with some embodiments, once T_{A} is determined, assembly of CSI can be performed for the determined T_{A}. For the purpose of description of the present disclosure, a single T_{A} value is used for the entire sensing space.

In an implementation, both the sensing transmitter and the sensing receiver may be assumed to be stationary. Accordingly, the coherence time T_{c} of the transmission channel may be related to the frequency of sensing transmission. In an implementation, T_{A} may be a linear function of the channel coherence time, i.e., T_{A}=αT_{c}+/β. In some implementations, T_{A} may be a quadratic function of the channel coherence time, i.e., T_{A}=αT_{c}²+βT_{c}+γ.

In some implementations, T_{A} may be a function of the channel coherence bandwidth B_{c}, i.e.,

$${T}_{A} = \frac{α}{{B}_{c}} + β .$$

Other techniques of determining T_{A} that are not discussed here are contemplated herein.

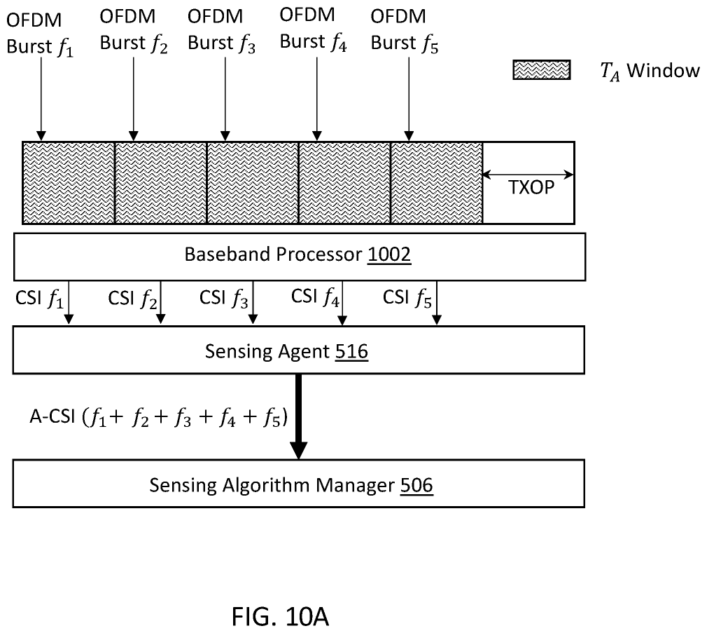

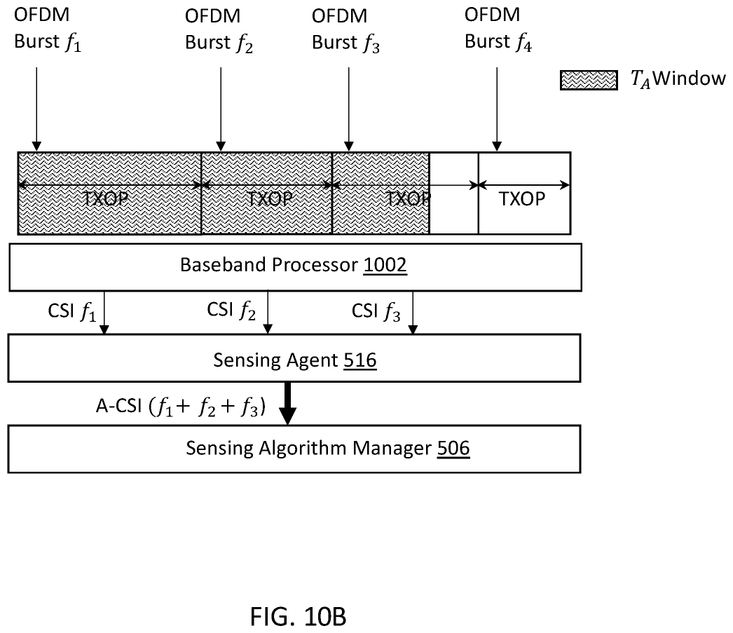

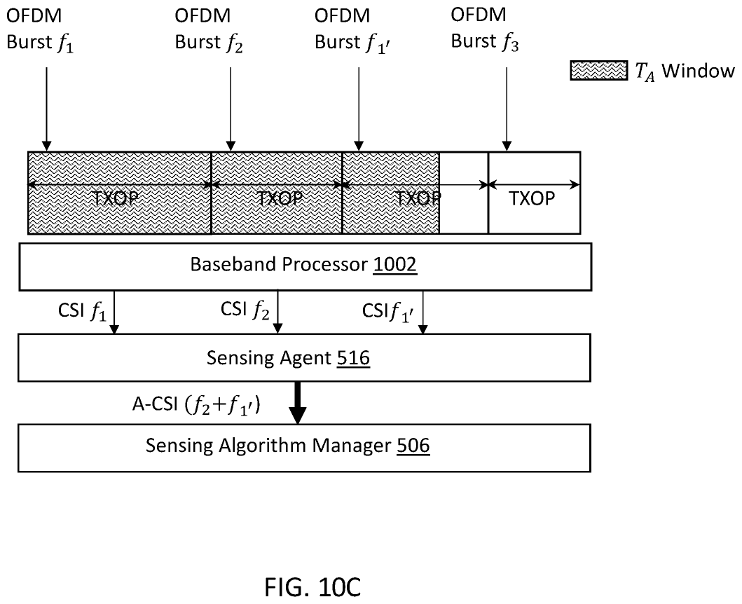

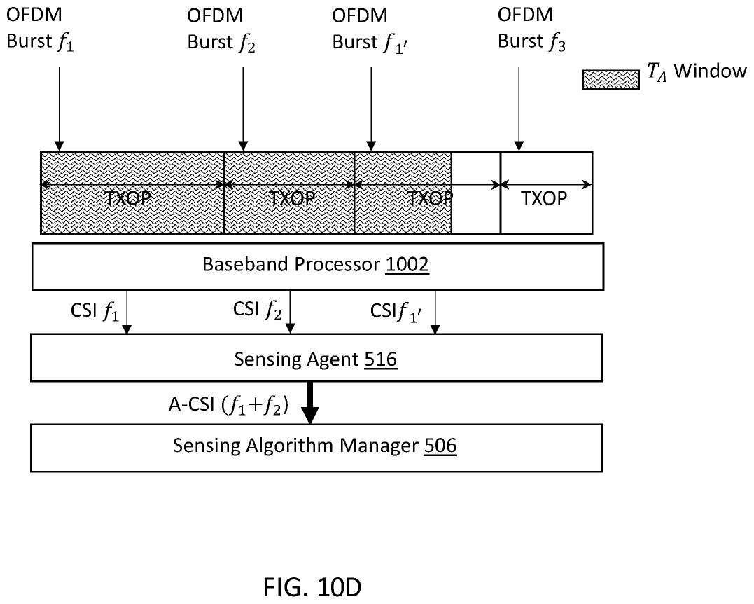

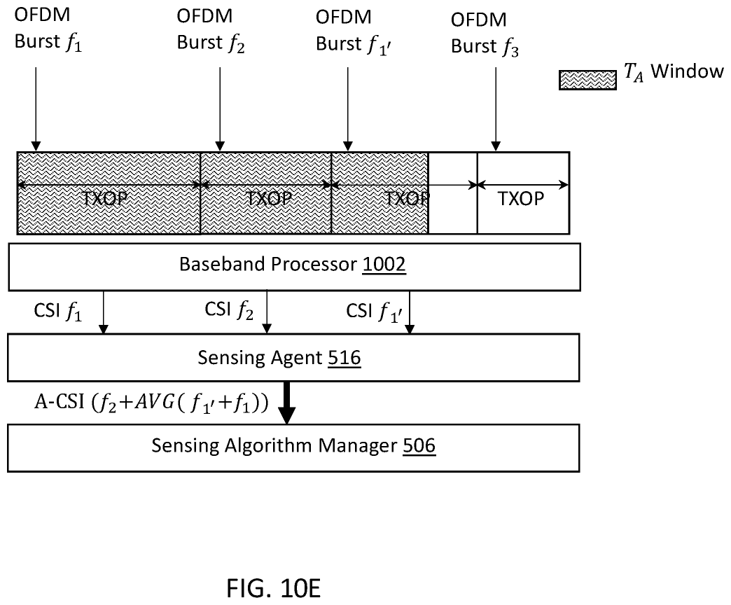

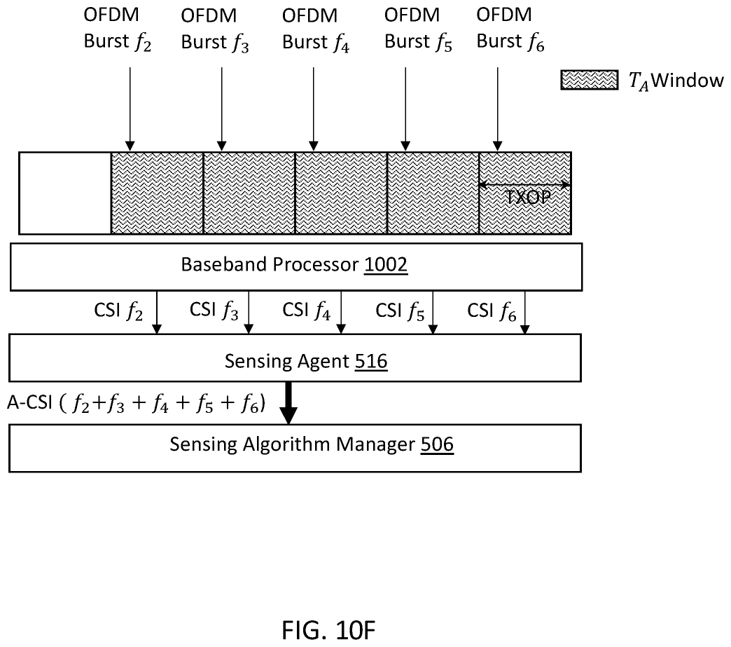

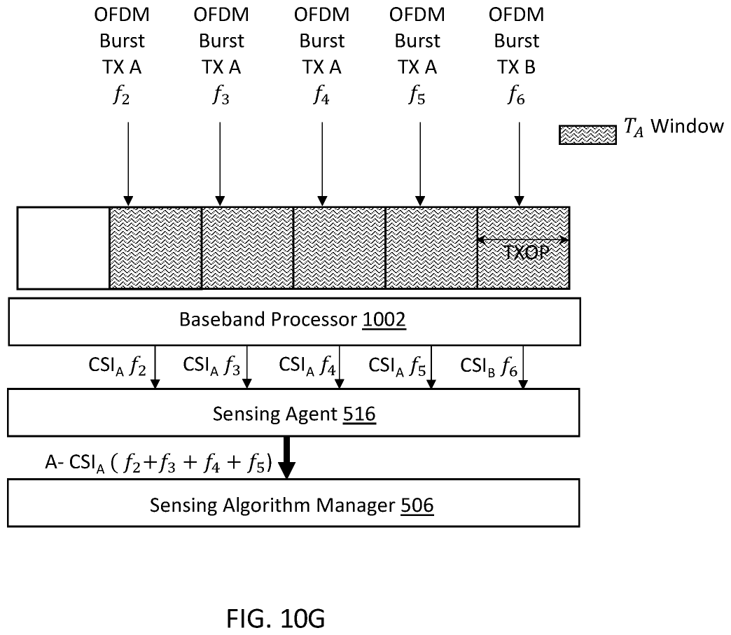

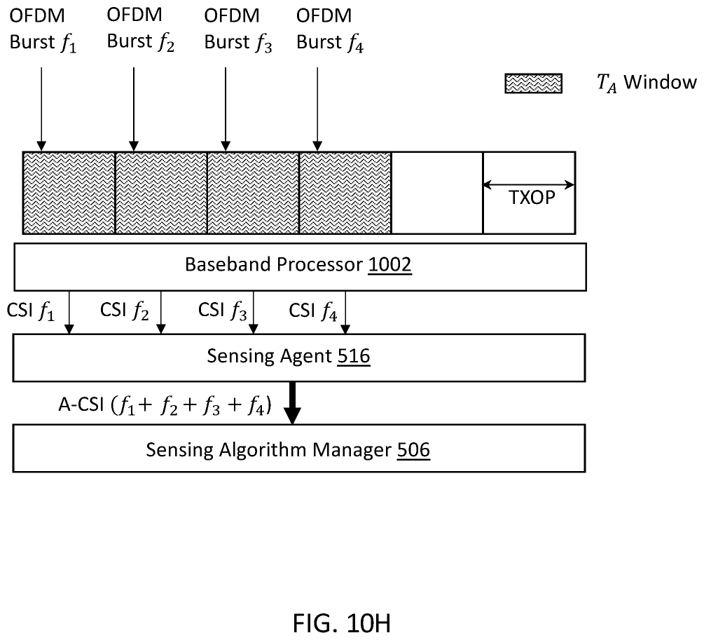

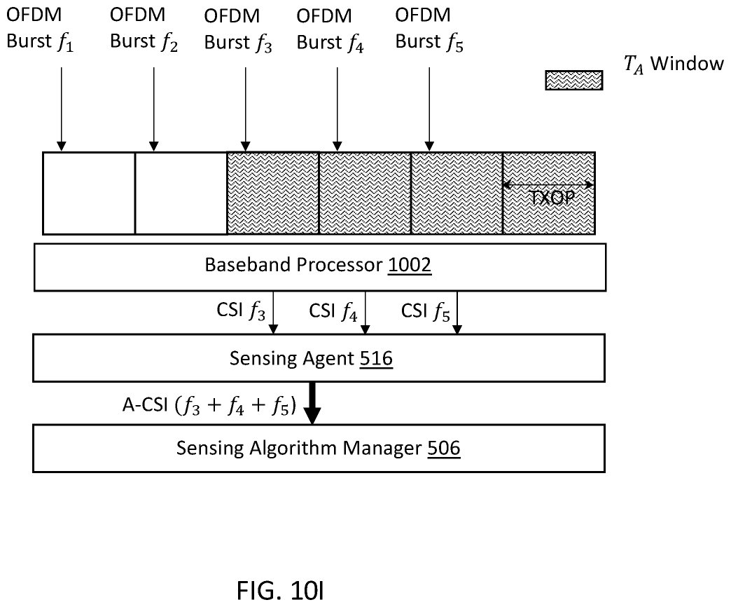

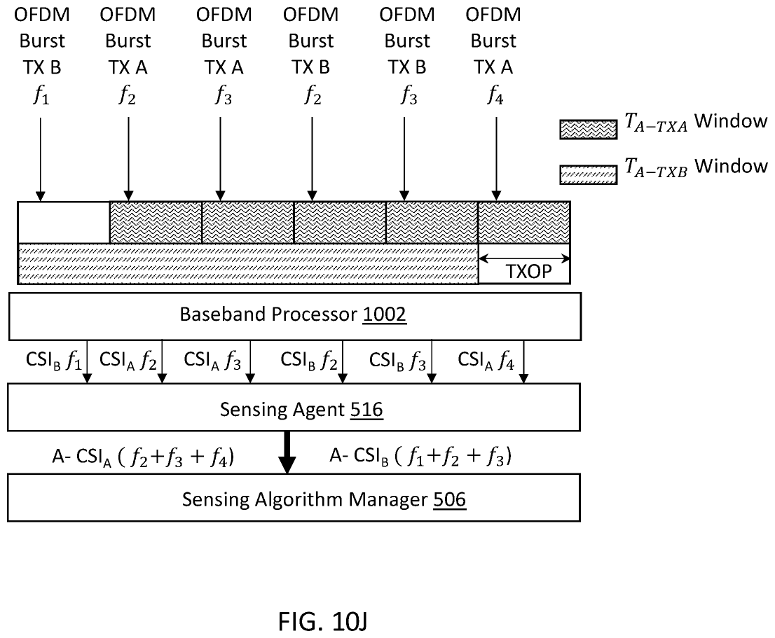

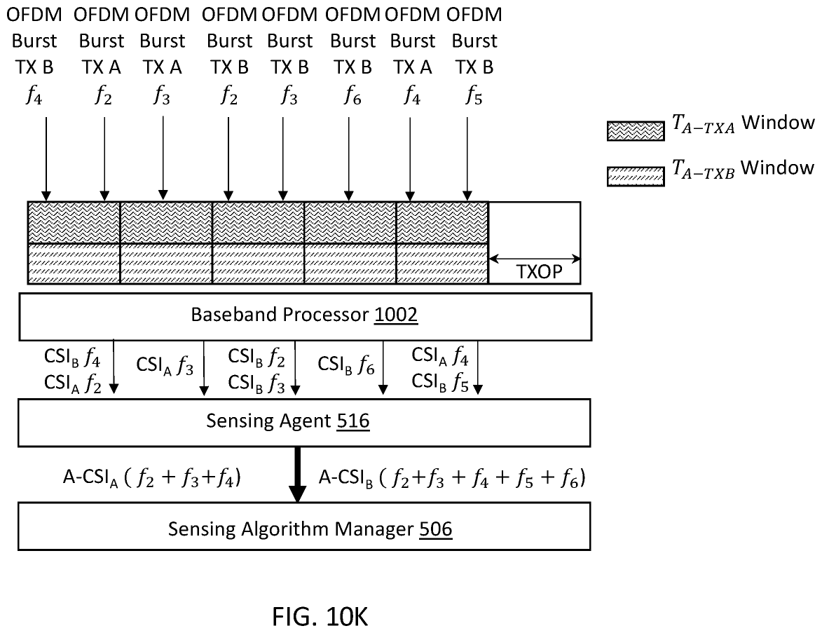

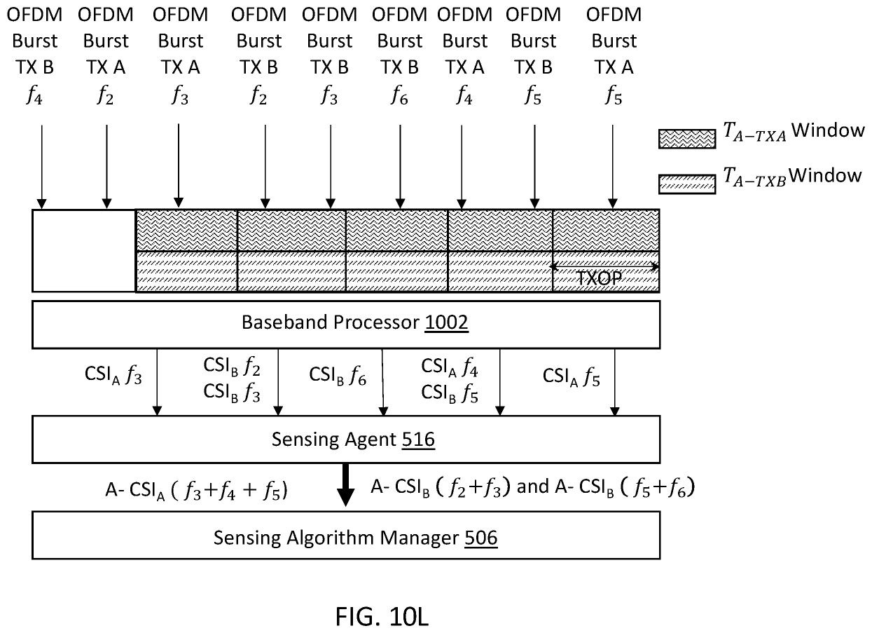

FIG. 10A illustrates an example of assembly of CSI for a sensing transmitter across multiple OFDM bursts in a time window T_{A}, according to some embodiments.

According to an implementation, sensing receiver 502 may initiate a sensing transmission from a sensing transmitter (for example, first sensing transmitter 504-1) using available UL-OFDMA channels or available uplink RUs that are not needed for scheduled data transmissions.

According to an implementation, sensing receiver 502 may secure a first TXOP which may be allocated to the first sensing transmission by sensing transmitter 504-1. In an example, the sensing transmission from the sensing transmitter may include multiple non-contiguous frequency sub-bands or RUs, depending on what bandwidth was available for use in the first TXOP. In an implementation, sensing receiver 502 may generate CSI for each tone in the entire wideband signal for the first TXOP. In an example, sensing receiver 502 may be aware of the tones that were allocated to sensing transmitter 504-1 in the first TXOP and may generate the CSI for those tones together with the location information for the tones with respect to total wideband channel.

In an implementation, sensing receiver 502 may initiate a sensing transmission from the same sensing transmitter in next TXOP, i.e., second TXOP, but from a different portion of the wideband (i.e., a portion of the wideband that the sensing transmitter did not transmit in during the first TXOP). According to an implementation, sensing receiver 502 may request the initiation from the different portion of the wideband channel in a sensing trigger message. Sensing receiver 502, may then generate CSI for each tone in the entire wideband signal for the second TXOP. In an implementation, sensing receiver 502 may be aware of the tones that were allocated to the sensing transmitter in the second TXOP and may generate the CSI from those tones together with the location information for the tones with respect to the total wideband channel. According to an implementation, sensing receiver 502 may then combine the CSI obtained from the tones allocated to the sensing transmitter in the first TXOP with the CSI obtained from the tones allocated to the sensing transmitter in the second TXOP, making the collective CSI values more absolute.

In accordance with some embodiments, sensing receiver 502 may combine the CSI for two or more TXOP until CSI are obtained from sensing transmissions from the same sensing transmitter for either the entire wideband channel (or a sufficient contiguous wideband as desired by sensing receiver 502) or until time delay to next TXOP is greater than T_{A} for the CSI measurement to be effective for combining with the previous CSI measurement, i.e., being useful for sensing movement or motion.

According to some embodiments, sensing agent 516 may utilize the value of T_{A} to determine absolute time window over which sensing agent 516 may assemble CSI from sensing transmissions from the same sensing transmitter before processing A-CSI to detect movement. In some examples, a number of OFDM bursts over which CSI may be assembled may be calculated by sensing agent 516 based on the value of T_{A} and the OFDM burst duration (where the same length OFDM burst is used for each frame) using equation (8), provided below.

$${N}_{Bursts} = \frac{{T}_{A}}{{Duration}_{Burst}} \qquad ( 8 )$$

FIG. 10A depicts one exemplary illustration in which five OFDM bursts are described, where a sensing transmitter transmits one burst at one TXOP and each burst is of equal duration satisfying the criterion for NDP transmission. Each OFDM burst may occupy five different and mutually exclusive component bandwidths, i.e., f₁, f₂, f₃, f₄, and f₅. In an example, each component bandwidth may be of equal duration, where T_{A} and Duration_{Burst} are such that N_{Bursts}=5.

Referring back to FIG. 10A, the OFDM bursts may be received by baseband processor 1002 of sensing receiver 502. In an implementation baseband processor 1002 may be processor 508 of sensing receiver 502. In an implementation, baseband processor 1002 may calculate the CSI in each symbol of the preamble of the burst. In an implementation, baseband processor 1002 may pass the CSI to sensing agent 516. Sensing agent 516 may store the CSI values associated with the sensing transmitter and the local information about the component bandwidth of each CSI value in sensing measurement storage 518. In an example implementation, sensing agent 516 may combine the CSI value with the local information with a time stamp indicating when the measurement was made. In an implementation, sensing agent 516 may store the CSI values from subsequent OFDM bursts until T_{A} is full. Once T_{A} is full, sensing agent 516 may assemble all CSI values to generate A-CSI. In an implementation, sensing agent 516 may send the A-CSI to sensing algorithm manager 506. This may be illustrated algebraically as shown below.

```
A − CSI_{A} = 0
T_{R} = T_{A}
For i = 1..n
  j = i + 1
  T_{R} = T_{R} − D_{B}_{ⱼ}
  if T_{R} < 0, then exit
  A − CSI_{A} = A − CSI_{A} + CSI_{A}
end for
```

In an implementation, once the A-CSI is processed, all CSI values that comprise the A-CSI may be discarded and the process may begin again. In some implementations, the OFDM burst duration may vary from frame to frame (for example, because the number of data symbols in the burst varies). In an example, the value of T_{A} may be decremented with each subsequent ODFM burst duration until such decrement results in a value less than zero. In a computed example, let the OFDM burst index be indicated by i, where the Bᵢ is the i^{th} OFDM burst. Let the duration of burst Bᵢ be D_{B}_{ᵢ}. Let T_{R} be an intermediate variable that represents the remaining time left for CSI assembly. Initially, T_{R}=T_{A}. Then for the sensing transmitter, the duration of the transmit burst may be compared to the remaining time T_{R} left for CSI assembly. If there may be sufficient T_{R} to include the burst, then the CSI for that burst may be combined with the CSI assembled for that sensing transmitter in the T_{A} window. If T_{R} may not be sufficient to include the burst, then the assembled CSI for that sensing transmitter may be processed in sensing algorithm manager 506. An example of assembly of CSI for the sensing transmitter across multiple OFDM unequal bursts in the time window T_{A} is shown in FIG. 10B. FIG. 10B describes first OFDM burst transmitting at f₁, second OFDM burst transmitting at f₂, third OFDM burst transmitting at f₃, and fourth OFDM burst transmitting at f₄ are unequal.

As described in FIG. 10A and FIG. 10B, if the sensing transmitter is transmitting at a frequency for which there is no CSI in the assembled CSI for that sensing transmitter, then the new CSI is added to the existing CSI in the assembled CSI.

FIG. 10C depicts example of assembly of CSI for a sensing transmitter across multiple unequal OFDM bursts in TA with overwrite. In an implementation, while combining a new CSI to assembled CSI, if the sensing transmitter is transmitting at a frequency for which there is already CSI in the assembled CSI for that sensing transmitter, then the most recent CSI may overwrite the existing CSI. Four OFDM bursts, with unequal duration, at different frequencies are described in FIG. 10C. For example, first OFDM burst transmitting at f₁, second OFDM burst transmitting at f₂, third OFDM burst transmitting at f₁, and fourth OFDM burst transmitting at f₃. Fourth OFDM burst transmission occurred after the TA window was fully occupied, therefore, sensing measurements associated with fourth OFDM burst cannot be considered for assembled CSI value. Therefore, baseband processor 1002 may receive CSI values from first, second and third OFDM bursts, denoted as CSI f₁, CSI f₂, and CSI f_{1′}. As first OFDM burst and third OFDM burst are being transmitted at same frequency f₁, CSI values for f₁ may be duplicated. Therefore, according to an implementation, the most recent CSI value for the same frequency may overwrite previous CSI value for the same frequency, i.e., CSI f_{1′} may overwrite CSI f₁. Sensing agent 516 may then generate A-CSI by considering CSI f₂ and CSI f_{1′}.

As FIG. 10C depicted the implementation of overwriting CSI value, FIG. 10D illustrates an example of assembly of CSI for one sensing transmitter across multiple unequal OFDM bursts in an assembly window TA with discard. With reference to FIG. 10D, in view of FIG. 10C, first OFDM burst and third OFDM burst are being transmitted at same frequency f₁, CSI values for f₁ may be duplicated. Therefore, according to the implementation, most recent CSI value for the same frequency may be discarded and previous CSI value for the same frequency can be considered for calculation, i.e., CSI f_{1′} may be discarded and CSI f₁ may be considered for calculation of A-CSI. Sensing agent 516 may then generate A-CSI by considering CSI f₂ and CSI f₁.

FIG. 10E illustrates an implementation of assembly of CSI for one sensing transmitter across multiple unequal OFDM bursts in a time window T_{A} with average. With respect to this particular implementation, if the sensing transmitter is transmitting at a frequency for which there is already CSI in the assembled CSI for that sensing transmitter, the current CSI can be averaged with the pre-existing CSI, which will improve the SNR of the measurement overall. If there is partial overlap between the frequency that the current CSI is calculated on and the frequencies for which there is already CSI in the assembled CSI, then the new CSI values may overwrite the existing CSI values in the region of overlap, or the new CSI values in the region of overlap may be discarded and the existing CSI values may be kept, or the new CSI values may be averaged with the existing CSI values in the region of overlap. Referring to FIG. 10E, where first OFDM burst and third OFDM burst are transmitting at same frequency f₁, average of CSI values, i.e., CSI f₁ and f_{1′} may be considered. Sensing agent 516 may then generate A-CSI by considering CSI f₂ and AVG(CSI f₁+CSI f_{1′}).

Referring back to FIG. 10A, a wideband channel divided into six component bands may receive five OFDM bursts inside the T_{A} window. CSI value pertaining to each OFDM burst inside the T_{A} window may be received by the baseband processor. Sensing agent 516 may generate based upon CSI values received by the baseband processor. A-CSI is processed and analyzed by sensing algorithm movement detection unit to determine movement or motion occurred in sensing space.

Particularly, for use of a rolling window, as with the absolute window, sensing agent 516 uses the value of T_{A} to determine the time period over which sensing agent 516 may assemble CSI from sensing transmissions from the same sensing transmitter before processing the A-CSI to detect movement. Also as with the absolute window, in some examples, a number of OFDM bursts over which CSI may be assembled can be calculated by the sensing algorithm based on the value of T_{A} and the OFDM burst duration.

In contrast to the absolute window and in implementation of a rolling window, the entire T_{A} window is shifted such that the end of the window includes the CSI calculated on the most recently received OFDM burst. This shifting of the time window may cause the CSI calculated on one or more previous bursts to be discarded because it is no longer in the T_{A} window. The implementation of assembly of CSI for a sensing transmitter across multiple equal OFDM bursts in a rolling assembly window of period T_{A} with minimal shift has been depicted in FIG. 10F.

As depicted in FIG. 10A, first, second, third, fourth, and fifth OFDM burst are inside T_{A} window. CSI values for the same OFDM bursts are calculated. However, as depicted in FIG. 10F, T_{A} window is shifted and as such sixth OFDM burst transmitting at f₆ now falls inside T_{A} window. In this particular context, second through sixth OFDM burst fall inside the T_{A} window and first OFDM burst fall outside the T_{A} window. CSI value of first OFDM burst may be discarded and CSI values of second, third, fourth, fifth, and sixth OFDM bursts may be considered for calculating A-CSI. Sensing agent 516 may generate A-CSI by combining CSI (f₂+f₃+f₄+f₅+f₆). Based upon calculated A-CSI, sensing algorithm manager 506 may determine movement or motion occurred in sensing space.

In some cases, all OFDM bursts may not belong to the same sensing transmitter. For example, first OFDM burst may belong to a first sensing transmitter 504-1, while second OFDM burst may belong to second sensing transmitter 504-2. FIG. 10G depicts an exemplary implementation of assembly of CSI for a sensing transmitter across multiple OFDM bursts in a rolling assembly window of period T_{A} where the final transmission is from a different sensing transmitter. As described in FIG. 10G, second OFDM burst, third OFDM burst, fourth OFDM burst, and fifth OFDM burst are being transmitted by one sensing transmitter, while sixth OFDM burst is being transmitted by another sensing transmitter. When OFDM burst is transmitted by a sensing different transmitter than the other one or more OFDM bursts, or there is no transmission from a sensing transmitter in that particular TXOP, T_{A} window still may be shifted discarding CSI value of the previous OFDM burst. Now that the T_{A} window is shifted such as sixth OFDM burst falls inside the T_{A} window, first OFDM burst (not shown in the figure) may be discarded. Baseband processor 1002 may receive CSI values respective to second through sixth OFDM bursts. However, as implicated, sixth OFDM burst transmitted by other sensing transmitter than that of the second through fifth OFDM bursts, CSI value pertaining to sixth OFDM burst may be discarded. Sensing agent 516 may only consider CSI values of second OFDM burst, third OFDM burst, fourth OFDM burst, and fifth OFDM burst, discarding CSI value of sixth OFDM burst. A-CSI is generated by combining CSI (f₂+f₃+f₄+f₅). Based upon calculated A-CSI, sensing algorithm manager 506 may determine movement or motion occurred in sensing space.

In one example, when an OFDM burst received from a sensing transmitter is outside the T_{A} window, the entire T_{A} window may be shifted by a fixed time increment that is sufficient to include the most recent OFDM burst but which might be greater than what is needed to include the most recent OFDM burst. Any CSI values that were calculated previously which are outside the T_{A} window (i.e., which have “aged-out”) may be discarded.

FIG. 10H and FIG. 10I depict exemplary implementation of assembly of CSI for a sensing transmitter across multiple OFDM bursts in a rolling assembly window of period T_{A} with fixed shift of the T_{A} window. FIG. 10H demonstrates that T_{A} window encompasses four OFDM bursts. A-CSI is calculated based upon CSI values associated with first, second, third and fourth OFDM bursts. As depicted in FIG. 10I, T_{A} is incremented by fixed amount resulting in dropping first and second OFDM bursts outside the T_{A} window. In some implementations, when an OFDM burst received from a sensing transmitter is outside the T_{A} window, the T_{A} window is reset such that the most recently received OFDM burst may become the first OFDM burst in the new T_{A} window and all CSI calculated on OFDM bursts that were previously in the window are discarded. For example, when T_{A} shifted, the first and second OFDM bursts fell outside the T_{A} window. Upon reset, the most recently received OFDM burst may become the first OFDM burst (in this example, the third OFDM burst). All CSI values starting from the third OFDM burst are calculated to generate A-CSI, discarding previous CSI values.

FIG. 10B to FIG. 10I describes multiple implementations and examples illustrating CSI value measurements with respect to an absolute or a rolling T_{A} window, prominently, for the signal transmission from a single sensing transmitter. Similar implementations can be applied for CSI value measurements when the signal transmission is subject to multiple transmitters. In some embodiments, sensing receiver 502 may initiate a sensing transmission from one or more sensing transmitters at one or more TXOPs. In some implementations, the sensing transmission may be initiated using available UL-OFDMA channels or available component bands that are not occupied with scheduled data transmissions. Such available component bands may be allocated to two or more sensing transmitters.

FIG. 10J depicts an exemplary illustration for assembly of CSI across OFDM bursts from multiple transmitters in an absolute T_{A} window. As described in FIG. 10J, at least two transmitters, namely first sensing transmitter (TX A) and second sensing transmitter (TX B), are transmitting in an absolute T_{A} window. Second sensing transmitter transmits an OFDM burst in f₁ in first TXOP. The T_{A-TXB} window may begin at this TXOP. First sensing transmitter transmits an OFDM burst in f₂ in second TXOP. The T_{A-TXA} window may begin at this TXOP. In the third TXOP, the first sensing transmitter may transmit an OFDM burst in f₃. In the fourth TXOP, second sensing transmitter B may transmit an OFDM burst in f₂. In the fifth TXOP, sensing transmitter B may transmit an OFDM burst in f₃. The T_{A-TXB} window ends at this TXOP. In the sixth TXOP, first sensing transmitter may transmit an OFDM burst in f₄. The T_{A-TXA} window ends at this TXOP.

Referring to FIG. 10J, a sensing receiver receives the sensing transmissions from first sensing transmitter and second sensing transmitter. The sensing transmissions from each of the sensing transmitters may consist of multiple component bands, depending on what bandwidth was available for use in each TXOP during the T_{A} window for the particular sensing transmitter. At sensing receiver, baseband processor 1002 may generate CSI for each tone in the entire wideband receive signal for the each TXOP. The sensing algorithm may be aware of the component bands that were allocated to each of the sensing transmitters in each TXOP and T_{A} window for each of the sensing transmitters. Sensing agent 516 may obtain and store the CSI for the received component bands together in sensing measurement storage 518. The CSI value may be stored in combination with location information for the component band with respect to total wideband channel for each of the sensing transmitters, and a time stamp indicating when the sensing measurement was made.

Sensing agent 516 may then combine the CSI value obtained from the component bands allocated to each sensing transmitter across the TXOPs that are included in the T_{A} window for that sensing transmitter. As illustrated in FIG. 10J, assembled CSI for first transmitter (A-CSI_{A}) consists of the CSI from f₂, f₃, and f₄. The assembled CSI for second transmitter (A-CSI_{B}) consists of the CSI from f₁, f₂, and f₃. A-CSI_{B} is assembled, and may be sent to sensing algorithm manager 506, after the fifth TXOP when the T_{A-TXB} window ends. A-CSI_{A} is assembled, and may be sent to sensing algorithm manager 506, after the sixth TXOP when the T_{A-TXA} window ends.

FIG. 10K illustrates an exemplary implementation of multiple transmitters (TX A and TX B) transmitting in different component bands in the same TXOP. In the first TXOP, second sensing transmitter (TX B) may transmit an OFDM burst in f₄ and the T_{A-TXB} window for second sensing transmitter may begin at the first TXOP. Also, first sensing transmitter (TX A) may transmit an OFDM burst in f₂ and the T_{A-TXA} window for first sensing transmitter may begin at first TXOP. In second TXOP, first sensing transmitter may transmit an OFDM burst in f₃. In third TXOP, second sensing transmitter may transmit an OFDM burst in f₂ and f₃. In fourth TXOP, second sensing transmitter may transmit an OFDM burst in f₆. In fifth TXOP, first sensing transmitter may transmit an OFDM burst in f₄ and second sensing transmitter may transmit an OFDM burst in f₅. The end of the T_{A-TXB} window may have been reached at this stage and sensing agent 516 may generate the A-CSI_{B} consisting of CSI for component bands f₂+f₃+f₄+f₅+f₆ and send it to sensing algorithm manager 506 for motion detection. The T_{A-TXA} window may also end at this TXOP and sensing agent 516 may generate the A-CSI_{A} consisting of CSI for component bands f₂+f₃+f₄ send it to sensing algorithm manager 506 for motion detection.

FIGS. 10J and 10K described multiple transmitters transmitting during absolute T_{A} window. FIG. 10L depicts an exemplary implementation of multiple transmitters transmitting during rolling T_{A} window. In some implementations, in the sixth TXOP, first sensing transmitter transmits an OFDM burst in f₅. Both the T_{A-TXA} window and the T_{A-TXB} window advance by one TXOP. Sensing agent 516 may pass the A-CSI_{A} consisting of CSI for component bands f₃+f₄+f₅, corresponding to first sensing transmitter, to sensing algorithm manager 506 for motion detection. The component bands, for second sensing transmitter that are in the T_{A-TXB} window, are not contiguous, and instead, are in two groups. Sensing agent 516 may pass two A-CSI_{B} to sensing algorithm manager 506, the first consisting of CSI for component bands f₂+f₃ and the second consisting of CSI for component bands f₅+f₆. In another implementation, once the A-CSI for a given transmitter has fulfilled the requirements of sensing agent 516, sensing agent 516 may convert the A-CSI for the sensing transmitter to A-TD-CRI, and use known processes to minimize the amount of information that is sent to sensing agent 516.

FIG. 11 depict flowchart 1100 for Wi-Fi sensing carried out by sensing receiver 502, according to some embodiments.

In a brief overview of an implementation of flowchart 1100, at step 1102, a time window is determined. At step 1104, a plurality of sensing transmission is received from a sensing transmitter in the determined time window. At step 1106, CSI is generated in a frequency domain based on the plurality of sensing transmissions. At step 1108, selected CSI is identified from among the corresponding CSI. At step 1110, the selected CSI are combined to generate A-CSI. At step 1112, information representative of the A-CSI is sent to sensing algorithm manager 506.

Step 1102 includes determining a time window. In an implementation, sensing receiver 502 may be configured to determine the time window. In an example, the time window may be of a predetermined length of time. In an implementation, the time window may be configured to encompass a predetermined number of transmission opportunity periods. During each of the predetermined number of transmission opportunity periods, one sensing transmission from one sensing transmitter may be received.

Step 1104 includes receiving a plurality of sensing transmissions from a sensing transmitter in the time window. In an implementation, sensing receiver 502 may be configured to receive the plurality of sensing transmissions from the sensing transmitter in the determined time window. In an example, the sensing transmitter may be first sensing transmitter 504-1.

Step 1106 includes generating CSI in a frequency domain based on the plurality of sensing transmissions. In an implantation, sensing receiver 502 may be configured to generate CSI in the frequency domain based on the plurality of sensing transmission. In an implementation, sensing receiver 502 may generate a plurality of sensing measurements representing the CSI based on the plurality of sensing transmissions.

Step 1108 includes identifying selected CSI from among the corresponding CSI. In an implementation, sensing receiver 502 may be configured to identify the selected CSI from among the corresponding CSI. According to an implementation, sensing receiver 502 may identify, as the selected CSI, the corresponding CSI associated with the sensing transmissions associated with contiguous component bands from the sensing transmitter. In some implementations, sensing receiver 502 may identify, as first selected CSI, the corresponding CSI associated with the sensing transmissions associated with first contiguous component bands from the sensing transmitter. Further, sensing receiver 502 may identify, as second selected CSI, the corresponding CSI associated with the sensing transmissions associated with second contiguous component bands from the sensing transmitter.

In some implementations, identifying the selected CSI may include determining that corresponding CSI associated with a first sensing transmission of the plurality of sensing transmissions and corresponding CSI associated with a second sensing transmission of the plurality of sensing transmissions are associated with same component bands from the sensing transmitter, and including the corresponding CSI associated with the second sensing transmission in the selected CSI and excluding the CSI associated with the first sensing transmission in the selected CSI. In an example, the second sensing transmission may be received later in time than the first sensing transmission.

According to some implementations, identifying the selected CSI may include determining that corresponding CSI associated with the first sensing transmission of the plurality of sensing transmissions and corresponding CSI associated with the second sensing transmission of the plurality of sensing transmissions are associated with same component bands from the sensing transmitter, and including the corresponding CSI associated with the first sensing transmission in the selected CSI and discarding the CSI associated with the second sensing transmission in the selected CSI. In an example, the second sensing transmission may be received later in time than the first sensing transmission.

According to some embodiments, identifying the selected CSI may include determining that corresponding CSI associated with the first sensing transmission of the plurality of sensing transmissions and corresponding CSI associated with the second sensing transmission of the plurality of sensing transmissions are associated with same component bands from the sensing transmitter, where the second sensing transmission is received later in time than the first sensing transmission, combining the corresponding CSI associated with the first sensing transmission and the CSI associated with the second sensing transmission, and including the combined CSI in the selected CSI.

Step 1110 includes combining the selected CSI to generate A-CSI. According to an implementation, sensing receiver 502 may be configured to combine selected the CSI to generate the A-CSI. In an implementation, sensing receiver 502 may generate time domain channel representation information (TD-CRI) of the A-CSI.

Step 1112 includes sending information representative of the A-CSI to sensing algorithm manager 506. According to an implementation, sensing receiver 502 may be configured to send the information representative of the A-CSI to sensing algorithm manager 506. In an example, the information representative of the A-CSI may include the A-CSI. In some examples, the information representative of the A-CSI may include the TD-CRI

According to some implementations, sensing receiver 502 may be configured to receive a subsequent sensing transmission from the sensing transmitter after the time window, shift the time window to include the subsequent sensing transmission and a portion of the plurality of sensing transmissions, generate a subsequent CSI based on the subsequent sensing transmission, and combine the subsequent CSI with a portion of the selected CSI to generate subsequent A-CSI.

In some implementations, sensing receiver 502 may be configured to receive a subsequent sensing transmission after the time window and determine a subsequent time window configured to encompass a plurality of subsequent transmissions received after the time window.

FIG. 12 depicts flowchart 1200 for Wi-Fi sensing carried out by sensing receiver 502 coupled to multiple sensing transmitters. At step 1202, a time window is determined. At step 1204, a plurality of sensing transmissions is received in the determined time window. The plurality of sensing transmission includes a first plurality of sensing transmission from first sensing transmitter 504-1 and a second plurality of sensing transmission from second sensing transmitter 504-2. At step 1206, CSI is generated based on the first plurality of sensing transmissions and the second plurality of sensing transmissions. At step 1208, selected CSI as a first selected CSI and a second selected CSI are identified. At step 1210, the first selected CSI are combined to generate first A-CSI and the second selected CSI are combined to generate second A-CSI. At step 1212, first information representative of the first A-CSI and second information representative of the second A-CSI are sent to sensing algorithm manager 506.

Step 1202 includes determining a time window. In an implementation, sensing receiver 502 may be configured to determine the time window. In an example, the time window may be of a predetermined length of time. In an implementation, the time window may be configured to encompass a predetermined number of transmission opportunity periods. During each of the predetermined number of transmission opportunity periods, one sensing transmission from one sensing transmitter may be received.

Step 1204 includes receiving a plurality of sensing transmissions in the determined time window. The plurality of sensing transmission includes a first plurality of sensing transmission from first sensing transmitter 504-1 and a second plurality of sensing transmission from second sensing transmitter 504-2. According to an implementation, sensing receiver 502 may be configured to receive the first plurality of sensing transmission from first sensing transmitter 504-1 and the second plurality of sensing transmission from second sensing transmitter 504-2.

Step 1206 includes generating the CSI based on the first plurality of sensing transmissions and the second plurality of sensing transmissions. Each of the first plurality of sensing measurements has corresponding CSI and each of the second plurality of sensing measurements has corresponding CSI. In an implementation, sensing receiver 502 may be configured to generate the CSI in the frequency domain based on the first plurality of sensing transmissions and the second plurality of sensing transmissions. In an implementation, sensing receiver 502 may be configured to generate the CSI in the frequency domain. In an implementation, sensing receiver 502 may generate a first plurality of sensing measurements representing the CSI based on the first plurality of sensing transmissions and a second plurality of sensing measurements representing the CSI based on the second plurality of sensing transmissions.

Step 1208 includes identifying, as a first selected CSI, the corresponding CSI associated with first sensing transmissions associated with contiguous component bands from first sensing transmitter 504-1 and identifying, as a second selected CSI, the corresponding CSI associated with second sensing transmissions associated with contiguous component bands from second sensing transmitter 504-2. In an implementation, sensing receiver 502 may be configured to identify, as the first selected CSI, the corresponding CSI associated with first sensing transmissions associated with contiguous component bands from first sensing transmitter 504-1 and identify, as the second selected CSI, the corresponding CSI associated with second sensing transmissions associated with contiguous component bands from second sensing transmitter 504-2.

Step 1210 includes combining the first selected CSI to generate first A-CSI and combining the second selected CSI to generate second A-CSI. In an implementation, sensing receiver 502 may be configured to combine the first selected CSI to generate the first A-CSI and the second selected CSI to generate the second A-CSI.

Step 1212 includes sending information representative of the A-CSI to sensing algorithm manager 506. In an implementation, sending information representative of the A-CSI to sensing algorithm manager 506 may include sending first information representative of the first A-CSI and sending second information representative of the second A-CSI to the sensing algorithm manager 506. According to an implementation, sensing receiver 502 may be configured to send the first information representative of the first A-CSI and the second information representative of the second A-CSI to sensing algorithm manager 506. In an example, the information representative of the A-CSI may include the A-CSI. In some examples, the information representative of the A-CSI may include the TD-CRI.

Embodiment 1 is a method for Wi-Fi sensing carried out by a sensing agent coupled to a transmitting antenna, a receiving antenna, and at least one processor configured to execute instructions. The method comprises determining, by the sensing agent, a time window; receiving, by the sensing agent, channel state information (CSI) in a frequency domain generated, by the at least one processor, based on a plurality of sensing transmissions received, via the receiving antenna, from a sensing transmitter in the time window, each of the plurality of sensing transmissions having corresponding CSI; identifying, by the sensing agent, selected CSI from among the corresponding CSI; combining, by the sensing agent, the selected CSI to generate assembled channel state information (A-CSI); and sending, by the sensing agent, information representative of the A-CSI to a sensing algorithm manager.

Embodiment 2 is the method of embodiment 1, wherein the information representative of the A-CSI includes the A-CSI.

Embodiment 3 is the method of embodiment 1 or 2, further comprising generating time domain channel representation information (TD-CRI) of the A-CSI, wherein the information representative of the A-CSI includes the TD-CRI

Embodiment 4 is the method of any of embodiments 1-3, wherein identifying the selected CSI includes: identifying, as the selected CSI, the corresponding CSI associated with the sensing transmissions associated with contiguous component bands from the sensing transmitter.

Embodiment 5 is the method of embodiment 4, wherein identifying the selected CSI includes: identifying, as first selected CSI, the corresponding CSI associated with the sensing transmissions associated with first contiguous component bands from the sensing transmitter, and identifying, as second selected CSI, the corresponding CSI associated with the sensing transmissions associated with second contiguous component bands from the sensing transmitter. Embodiment 6 is the method of any of embodiments 1-5, wherein the plurality of sensing transmissions are a first plurality of sensing transmissions from a first sensing transmitter. The method further comprises: receiving a second plurality of sensing transmissions from a second sensing transmitter in the time window, wherein generating the CSI is performed based on the first plurality of sensing transmissions and the second plurality of sensing transmissions, each of the first plurality of sensing measurements having corresponding CSI and each of the second plurality of sensing measurements having corresponding CSI, identifying the selected CSI includes identifying, as a first selected CSI, the corresponding CSI associated with first sensing transmissions associated with contiguous component bands from the first sensing transmitter and identifying, as a second selected CSI, the corresponding CSI associated with second sensing transmissions associated with contiguous component bands from the second sensing transmitter, combining the selected CSI to generate assembled channel state information (A-CSI) includes combining the first selected CSI to generate first A-CSI and combining the second selected CSI to generate second A-CSI, and sending information representative of the A-CSI to the sensing algorithm manager includes sending first information representative of the first A-CSI and sending second information representative of the second A-CSI to the sensing algorithm manager.

Embodiment 7 is the method of any of embodiments 1-6, further comprising; receiving, via the receiving antenna, a subsequent sensing transmission from the sensing transmitter after the time window; shifting the time window to include the subsequent sensing transmission and a portion of the plurality of sensing transmissions; generating a subsequent CSI based on the subsequent sensing transmission; and combining the subsequent CSI with a portion of the selected CSI to generate subsequent A-CSI.

Embodiment 8 is the method of any of embodiments 1-7, further comprising: receiving, via the receiving antenna, a subsequent sensing transmission after the time window; and determining, by the processor, a subsequent time window configured to encompass a plurality of subsequent transmissions received after the time window.

Embodiment 9 is the method of any of embodiments 1-8, wherein the time window is a predetermined length of time.

Embodiment 10 is the method of any of embodiments 1-9, wherein the time window is configured to encompass a predetermined number of transmission opportunity periods.

Embodiment 11 is the method of embodiment 10, wherein, during each of the predetermined number of transmission opportunity periods, one sensing transmission from one sensing transmitter is received.

Embodiment 12 is the method of any of embodiments 1-11, wherein identifying the selected CSI includes: determining that corresponding CSI associated with a first sensing transmission of the plurality of sensing transmissions and corresponding CSI associated with a second sensing transmission of the plurality of sensing transmissions are associated with same component bands from the sensing transmitter; and including the corresponding CSI associated with the second sensing transmission in the selected CSI and excluding the CSI associated with the first sensing transmission in the selected CSI, wherein the second sensing transmission is received later in time than the first sensing transmission.

Embodiment 13 is the method of any of embodiments 1-12, wherein identifying the selected CSI includes: determining that corresponding CSI associated with a first sensing transmission of the plurality of sensing transmissions and corresponding CSI associated with a second sensing transmission of the plurality of sensing transmissions are associated with same component bands from the sensing transmitter; and including the corresponding CSI associated with the first sensing transmission in the selected CSI and discarding the CSI associated with the second sensing transmission in the selected CSI, wherein the second sensing transmission is received later in time than the first sensing transmission.

Embodiment 14 is the method of any of embodiments 1-13, wherein identifying the selected CSI includes: determining that corresponding CSI associated with a first sensing transmission of the plurality of sensing transmissions and corresponding CSI associated with a second sensing transmission of the plurality of sensing transmissions are associated with same component bands from the sensing transmitter, wherein the second sensing transmission is received later in time than the first sensing transmission; combining the corresponding CSI associated with the first sensing transmission and the CSI associated with the second sensing transmission; and including the combined CSI in the selected CSI.

Embodiment 15 is a system for Wi-Fi sensing. The system comprises a sensing receiver including: a transmitting antenna, a receiving antenna, and at least one processor configured to execute instructions for: determining a time window; receiving channel state information (CSI) in a frequency domain generated based on a plurality of sensing transmissions received, via the receiving antenna, from a sensing transmitter in the time window, each of the plurality of sensing transmissions having corresponding CSI; identifying selected CSI from among the corresponding CSI; combining the selected CSI to generate assembled channel state information (A-CSI); and sending information representative of the A-CSI to a sensing algorithm.

Embodiment 16 is the system of embodiment 15, wherein the information representative of the A-CSI includes the A-CSI.

Embodiment 17 is the system of embodiment 15 or 16, wherein the at least one processor is further configured with instructions for generating time domain channel representation information (TD-CRI) of the A-CSI, wherein the information representative of the A-CSI includes the TD-CRI.

Embodiment 18 is the system of any of embodiments 15-17, wherein identifying the selected CSI is performed by identifying, as the selected CSI, the corresponding CSI associated with the sensing transmissions associated with contiguous component bands from the sensing transmitter.

Embodiment 19 is the system of embodiment 18, wherein identifying the selected CSI is performed by: identifying, as first selected CSI, the corresponding CSI associated with the sensing transmissions associated with first contiguous component bands from the sensing transmitter, and identifying, as second selected CSI, the corresponding CSI associated with the sensing transmissions associated with second contiguous component bands from the sensing transmitter.

Embodiment 20 is the system of any of embodiments 15-19, wherein the plurality of sensing transmissions are a first plurality of sensing transmissions from a first sensing transmitter, and the at least one processor is further configured with instructions for receiving a second plurality of sensing transmissions from a second sensing transmitter in the time window, wherein generating the CSI is performed based on the first plurality of sensing transmissions and the second plurality of sensing transmissions, each of the first plurality of sensing measurements having corresponding CSI and each of the second plurality of sensing measurements having corresponding CSI, identifying the selected CSI includes identifying, as a first selected CSI, the corresponding CSI associated with first sensing transmissions associated with contiguous component bands from the first sensing transmitter and identifying, as a second selected CSI, the corresponding CSI associated with second sensing transmissions associated with contiguous component bands from the second sensing transmitter, combining the selected CSI to generate assembled channel state information (A-CSI) includes combining the first selected CSI to generate first A-CSI and combining the second selected CSI to generate second A-CSI, and sending information representative of the A-CSI to the sensing algorithm manager includes sending first information representative of the first A-CSI and sending second information representative of the second A-CSI to the sensing algorithm manager.

Embodiment 21 is the system of any of embodiments 15-20, wherein the at least one processor is further configured with instructions for: receiving, from the receiving antenna, a subsequent sensing transmission from the sensing transmitter after the time window; shifting the time window to include the subsequent sensing transmission and a portion of the plurality of sensing transmissions; generating a subsequent CSI based on the subsequent sensing transmission; and combining the subsequent CSI with a portion of the selected CSI to generate subsequent A-CSI.

Embodiment 22 is the system of any of embodiments 15-21, wherein the at least one processor is further configured with instructions for: receiving, from the receiving antenna, a subsequent sensing transmission after the time window; and determining a subsequent time window configured to encompass a plurality of subsequent transmissions received after the time window.

Embodiment 23 is the system of any of embodiments 15-22, wherein the time window is a predetermined length of time.

Embodiment 24 is the system of any of embodiments 15-23, wherein the time window is configured to encompass a predetermined number of transmission opportunity periods.

Embodiment 25 is the system of embodiment 24, wherein, during each of the predetermined number of transmission opportunity periods, one sensing transmission from one sensing transmitter is received.

Embodiment 26 is the system of any of embodiments 15-25, wherein identifying the selected CSI is performed by: determining that corresponding CSI associated with a first sensing transmission of the plurality of sensing transmissions and corresponding CSI associated with a second sensing transmission of the plurality of sensing transmissions are associated with same component bands from the sensing transmitter; and including the corresponding CSI associated with the second sensing transmission in the selected CSI and excluding the CSI associated with the first sensing transmission in the selected CSI, wherein the second sensing transmission is received later in time than the first sensing transmission.

Embodiment 27 is the system of any of embodiments 15-26, wherein identifying the selected CSI is performed by: determining that corresponding CSI associated with a first sensing transmission of the plurality of sensing transmissions and corresponding CSI associated with a second sensing transmission of the plurality of sensing transmissions are associated with same component bands from the sensing transmitter; and including the corresponding CSI associated with the first sensing transmission in the selected CSI and discarding the CSI associated with the second sensing transmission in the selected CSI, wherein the second sensing transmission is received later in time than the first sensing transmission.

Embodiment 28 is the system of any of embodiments 15-27, wherein identifying the selected CSI is performed by: determining that corresponding CSI associated with a first sensing transmission of the plurality of sensing transmissions and corresponding CSI associated with a second sensing transmission of the plurality of sensing transmissions are associated with same component bands from the sensing transmitter, wherein the second sensing transmission is received later in time than the first sensing transmission; combining the corresponding CSI associated with the first sensing transmission and the CSI associated with the second sensing transmission; and including the combined CSI in the selected CSI.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by a sensing agent coupled to a transmitting antenna, a receiving antenna, and at least one processor configured to execute instructions, the method comprising:
determining, by the sensing agent, a time window;
receiving, by the sensing agent, channel state information (CSI) in a frequency domain generated, by the at least one processor, based on a plurality of sensing transmissions received, via the receiving antenna, from a sensing transmitter in the time window, each of the plurality of sensing transmissions having corresponding CSI;
identifying, by the sensing agent, selected CSI from among the corresponding CSI;
combining, by the sensing agent, the selected CSI to generate assembled channel state information (A-CSI); and
sending, by the sensing agent, information representative of the A-CSI to a sensing algorithm manager.

2. The method of claim 1, wherein the information representative of the A-CSI includes the A-CSI.

3. The method of claim 1, further comprising generating time domain channel representation information (TD-CRI) of the A-CSI, wherein the information representative of the A-CSI includes the TD-CRI.

4. The method of claim 1, wherein identifying the selected CSI includes:
identifying, as the selected CSI, the corresponding CSI associated with the sensing transmissions associated with contiguous component bands from the sensing transmitter.

5. The method of claim 4, wherein identifying the selected CSI includes:
identifying, as first selected CSI, the corresponding CSI associated with the sensing transmissions associated with first contiguous component bands from the sensing transmitter, and
identifying, as second selected CSI, the corresponding CSI associated with the sensing transmissions associated with second contiguous component bands from the sensing transmitter.

6. The method of claim 1, wherein the plurality of sensing transmissions are a first plurality of sensing transmissions from a first sensing transmitter, the method further comprising:
receiving a second plurality of sensing transmissions from a second sensing transmitter in the time window, wherein generating the CSI is performed based on the first plurality of sensing transmissions and the second plurality of sensing transmissions, each of the first plurality of sensing measurements having corresponding CSI and each of the second plurality of sensing measurements having corresponding CSI,
identifying the selected CSI includes identifying, as a first selected CSI, the corresponding CSI associated with first sensing transmissions associated with contiguous component bands from the first sensing transmitter and identifying, as a second selected CSI, the corresponding CSI associated with second sensing transmissions associated with contiguous component bands from the second sensing transmitter,
combining the selected CSI to generate assembled channel state information (A-CSI) includes combining the first selected CSI to generate first A-CSI and combining the second selected CSI to generate second A-CSI, and
sending information representative of the A-CSI to the sensing algorithm manager includes sending first information representative of the first A-CSI and sending second information representative of the second A-CSI to the sensing algorithm manager.

7. The method of claim 1, further comprising:
receiving, via the receiving antenna, a subsequent sensing transmission from the sensing transmitter after the time window;
shifting the time window to include the subsequent sensing transmission and a portion of the plurality of sensing transmissions;
generating a subsequent CSI based on the subsequent sensing transmission; and
combining the subsequent CSI with a portion of the selected CSI to generate subsequent A-CSI.

8. The method of claim 1, further comprising:
receiving, via the receiving antenna, a subsequent sensing transmission after the time window; and
determining, by the processor, a subsequent time window configured to encompass a plurality of subsequent transmissions received after the time window.

9. The method of claim 1, wherein the time window is a predetermined length of time.

10. The method of claim 1, wherein the time window is configured to encompass a predetermined number of transmission opportunity periods.

11. The method of claim 10, wherein, during each of the predetermined number of transmission opportunity periods, one sensing transmission from one sensing transmitter is received.

12. The method of claim 1, wherein identifying the selected CSI includes:
determining that corresponding CSI associated with a first sensing transmission of the plurality of sensing transmissions and corresponding CSI associated with a second sensing transmission of the plurality of sensing transmissions are associated with same component bands from the sensing transmitter; and
including the corresponding CSI associated with the second sensing transmission in the selected CSI and excluding the CSI associated with the first sensing transmission in the selected CSI, wherein the second sensing transmission is received later in time than the first sensing transmission.

13. The method of claim 1, wherein identifying the selected CSI includes:
determining that corresponding CSI associated with a first sensing transmission of the plurality of sensing transmissions and corresponding CSI associated with a second sensing transmission of the plurality of sensing transmissions are associated with same component bands from the sensing transmitter; and
including the corresponding CSI associated with the first sensing transmission in the selected CSI and discarding the CSI associated with the second sensing transmission in the selected CSI, wherein the second sensing transmission is received later in time than the first sensing transmission.

14. The method of claim 1, wherein identifying the selected CSI includes:
determining that corresponding CSI associated with a first sensing transmission of the plurality of sensing transmissions and corresponding CSI associated with a second sensing transmission of the plurality of sensing transmissions are associated with same component bands from the sensing transmitter, wherein the second sensing transmission is received later in time than the first sensing transmission;
combining the corresponding CSI associated with the first sensing transmission and the CSI associated with the second sensing transmission; and
including the combined CSI in the selected CSI.

15. A system for Wi-Fi sensing, comprising:
a sensing receiver including:
a transmitting antenna,
a receiving antenna, and
at least one processor configured to execute instructions for:
determining a time window;
receiving channel state information (CSI) in a frequency domain generated based on a plurality of sensing transmissions received, via the receiving antenna, from a sensing transmitter in the time window, each of the plurality of sensing transmissions having corresponding CSI;
identifying selected CSI from among the corresponding CSI;
combining the selected CSI to generate assembled channel state information (A-CSI); and
sending information representative of the A-CSI to a sensing algorithm manager.

16-19. (canceled)

20. The system of claim 15, wherein the plurality of sensing transmissions are a first plurality of sensing transmissions from a first sensing transmitter, and the at least one processor is further configured with instructions for
receiving a second plurality of sensing transmissions from a second sensing transmitter in the time window, wherein generating the CSI is performed based on the first plurality of sensing transmissions and the second plurality of sensing transmissions, each of the first plurality of sensing measurements having corresponding CSI and each of the second plurality of sensing measurements having corresponding CSI,
identifying the selected CSI includes identifying, as a first selected CSI, the corresponding CSI associated with first sensing transmissions associated with contiguous component bands from the first sensing transmitter and identifying, as a second selected CSI, the corresponding CSI associated with second sensing transmissions associated with contiguous component bands from the second sensing transmitter,
combining the selected CSI to generate assembled channel state information (A-CSI) includes combining the first selected CSI to generate first A-CSI and combining the second selected CSI to generate second A-CSI, and
sending information representative of the A-CSI to the sensing algorithm manager includes sending first information representative of the first A-CSI and sending second information representative of the second A-CSI to the sensing algorithm manager.

21. The system of claim 15, wherein the at least one processor is further configured with instructions for:
receiving, from the receiving antenna, a subsequent sensing transmission from the sensing transmitter after the time window;
shifting the time window to include the subsequent sensing transmission and a portion of the plurality of sensing transmissions;
generating a subsequent CSI based on the subsequent sensing transmission; and
combining the subsequent CSI with a portion of the selected CSI to generate subsequent A-CSI.

22-25. (canceled)

26. The system of claim 15, wherein identifying the selected CSI is performed by:
determining that corresponding CSI associated with a first sensing transmission of the plurality of sensing transmissions and corresponding CSI associated with a second sensing transmission of the plurality of sensing transmissions are associated with same component bands from the sensing transmitter; and
including the corresponding CSI associated with the second sensing transmission in the selected CSI and excluding the CSI associated with the first sensing transmission in the selected CSI, wherein the second sensing transmission is received later in time than the first sensing transmission.

27. The system of claim 15, wherein identifying the selected CSI is performed by:
determining that corresponding CSI associated with a first sensing transmission of the plurality of sensing transmissions and corresponding CSI associated with a second sensing transmission of the plurality of sensing transmissions are associated with same component bands from the sensing transmitter; and
including the corresponding CSI associated with the first sensing transmission in the selected CSI and discarding the CSI associated with the second sensing transmission in the selected CSI, wherein the second sensing transmission is received later in time than the first sensing transmission.

28. The system of claim 15, wherein identifying the selected CSI is performed by:
determining that corresponding CSI associated with a first sensing transmission of the plurality of sensing transmissions and corresponding CSI associated with a second sensing transmission of the plurality of sensing transmissions are associated with same component bands from the sensing transmitter, wherein the second sensing transmission is received later in time than the first sensing transmission;
combining the corresponding CSI associated with the first sensing transmission and the CSI associated with the second sensing transmission; and
including the combined CSI in the selected CSI.
